(19) United States
(12) Patent Application Publication
(10) Pub. No.: US 2010/0274478 A1
(43) Pub. Date: Oct. 28, 2010

(54) IMAGE TRANSFORMATION METHOD, IMAGE DISPLAY METHOD, IMAGE TRANSFORMATION APPARATUS AND IMAGE DISPLAY APPARATUS

(76) Inventor: Kenji Takahashi, Shiga (JP)

Correspondence Address: MCDERMOTT WILL & EMERY LLP, 600 13TH STREET, NW, WASHINGTON, DC, 20005-3096, US

(21) Appl. No.: 12/810,482

(22) PCT Filed: Dec. 9, 2008
(86) PCT No.: PCT/JP2008/003658

§ 371 Date: Jun. 24, 2010

(30) Foreign Application Priority Data
Jan. 7, 2008 (JP) 2008-00561

(51) Int. Cl. G01C 21/36; G06K 9/00; G08G 1/123; G09G 5/00

(52) U.S. Cl. 701/201; 382/104; 340/995.1; 345/633

(57) ABSTRACT

A first road shape in camera image data generated by a camera that captures images of the surroundings of a vehicle is recognized based on the camera image data. In addition, after reading map image data in the vicinity of the vehicle from a navigation unit, second point of interest coordinates existing in a second road shape in the map image data which was read and first point of interest coordinates existing in the first road shape are each detected and the first point of interest coordinates and the second point of interest coordinates are made to correspond to each other.

### BACKGROUND OF THE INVENTION

1. Field of the Invention

The present invention relates to methods and apparatuses provided for guiding a car to a recommended route in a car navigation system.

2. Description of the Related Art

Describing a car navigation system, a recommended route most suitable for a preset destination is set based on road map image data stored in a car navigation apparatus, and instructions as to whether to turn right or left are displayed on a display screen at key positions on the route, such as intersections, as the car travels toward the destination.

There is a known technology in the car navigation system wherein a driver can exactly know at which intersections he should change the direction of his car (for example, see Patent Document 1). According to the car navigation technology, when a travelling car equipped with the car navigation system approaches a certain point which is away by a given distance from a key position where it should turn right or left on the route, a map displayed on a screen display is changed to the sight of the intersection, and the position of the intersection is determined based on the position and optical conditions such as viewing angle and focal distance of a camera installed in the car, so that an arrow indicating the right turn or left turn (route information) is synthesized with the sight of the intersection.
Patent Document 1: Unexamined Japanese Patent Applications Laid-Open No. 07-63572

### DISCLOSURE OF THE INVENTION

### Problems to be Solved by the Invention

According to the car navigation technology recited in the Patent Document 1, the position of the intersection is determined based on the position and the optical conditions of the camera, so that the route information of the intersection to which the car should be guided is synthesized. This technical characteristic makes it necessary that:
the position, viewing angle and focal distance of the camera be determined:
the center of the camera viewing angle match the center of the intersection; and
the map information position inputted from the navigation apparatus match the position of the car.

Otherwise, the arrow of the right or left turn at the intersection cannot be correctly combined with the map information, which may misguide the car driver at the intersection.

A main object of the present invention is to establish a car navigation system which can instruct a person who is driving a car equipped with the system to turn in a right direction, right or left, at an intersection without relying on the position and optical conditions of a camera installed in the car.

1) An image transformation method according to the present invention comprises:

a first step in which a first road shape included in a camera image data generated by a camera that catches surroundings of a car equipped with the camera is recognized based on the camera image data; and

a second step in which a map image data of a vicinity of the car is read from a navigation apparatus, second point of interest coordinates present in a second road shape included in the read map image data and first point of interest coordinates present in the first road shape are respectively detected, and the first point of interest coordinates and the second point of interest coordinates are arranged to correspond to each other.

According to a preferable mode of the image transformation method, a contour component in the camera image data is detected based on a luminance signal of the camera image data, and the first road shape is recognized based on the contour component at an edge portion of a second image region having a pixel information equal to a pixel information of a first image region estimated as a road in the camera image data in the first step.

According to another preferable mode of the image transformation method, a road contour is recognized as the first road shape in the first step, second intersection contour coordinates in a road region are detected as the second point of interest coordinates in the map image data in the second step, and flexion point coordinates in the road contour are recognized as first intersection contour coordinates so that the recognized first intersection contour coordinates are detected as the first point of interest coordinates in the camera image data in the second step.

According to still another preferable mode of the image transformation method, a road contour is recognized as the first road shape in the first step, first intersection contour coordinates in a road region are recognized as the first point of interest coordinates in the camera image data in the second step, and in the case where the recognized first point of interest coordinates are insufficient as the first intersection contour coordinates, the insufficient first point of interest coordinates are estimated based on the recognized first point of interest coordinates in the second step.

According to still another preferable mode of the image transformation method, a road contour is recognized as the first road shape in the first step, second intersection contour coordinates in a road region are detected as the second point of interest coordinates in the map image data in the second step, and a first direction vector of the contour component in the camera image data is detected and first intersection contour coordinates are then recognized based on the detected first direction vector so that the recognized first intersection contour coordinates are detected as the first point of interest coordinates in the second step.

According to still another preferable mode of the image transformation method, a third step is further included, wherein a distortion generated between the first point of interest coordinates and the second point of interest coordinates that are arranged to correspond to each other is calculated, and coordinates of the map image data or the camera image data are converted so that an image of the map image data or the camera image data is transformed based on the calculated distortion.

According to still another preferable mode of the image transformation method, the distortion is calculated so that the first point of interest coordinates and the second point of interest coordinates correspond with each other in the third step.

According to still another preferable mode of the image transformation method, a second direction vector of a road region in the map image data and a first direction vector of the contour component in the camera image data are detected in the second step, the first direction vector and the second direction vector are arranged to correspond to each other in such a way that the first and second direction vectors make a minimum shift relative to each other in the third step, and the distortion is calculated based on a difference between the first and second direction vectors arranged to correspond to each other in the third step.

2) An image display method according to the present invention comprises:

the first and second steps of the image transformation method according to the present invention and a fourth step, wherein

the camera image data and the map image data are combined with each other in the state where the first point of interest coordinates and the second point of interest coordinates correspond to each other, and an image of the combined image data is displayed in the fourth step.

3) An image display method according to the present invention comprises:

the first-third steps of the image transformation method according to the present invention and a fifth step, wherein

a route guide image data positionally corresponding to the map image data is further read from the navigation apparatus in the first step,

coordinates of the route guide image data are converted in place of those of the map image data or the camera image data so that an image of the route guide image data is transformed based on the distortion in the third step, and

the transformed route guide image data and the untransformed camera image data are combined with each other in such a way that an image of the transformed route guide image data positionally corresponds to an image of the untransformed camera image data, and an image of the combined image data is displayed in the fifth step.

4) An image display method according to the present invention comprises:

the first-third steps of the image transformation method according to the present invention and a sixth step, wherein

a map image data including a route guide image data is read from the navigation apparatus as the map image data in the first step,

coordinates of the map image data including the route guide image data are converted so that an image of the map image data including the route guide image data is transformed based on the distortion in the third step, and

the transformed map image data including the route guide image data and the untransformed camera image data are combined with each other in such a way that an image of the transformed map image data including the route guide image data positionally corresponds to an image of the untransformed camera image data, and an image of the combined image data is displayed in the sixth step.

5) An image transformation apparatus according to the present invention comprises:

an image recognition unit for recognizing a first road shape in a camera image data generated by a camera that catches surroundings of a car equipped with the camera based on the camera image data;

a point of interest coordinate detection unit for reading a map image data of a vicinity of the car from a navigation apparatus, detecting second point of interest coordinates present in a second road shape included in the read map image data and first point of interest coordinates present in the first road shape, and arranging the first point of interest coordinates and the second point of interest coordinates to correspond to each other; and

a coordinate conversion processing unit for calculating a distortion generated between the first point of interest coordinates and the second point of interest coordinates arranged to correspond to each other by the point of interest coordinate detection unit, and converting coordinates of the map image data or the camera image data so that an image of the map image data or the camera image data is transformed based on the calculated distortion.

6) An image display apparatus according to the present invention comprises:

the image transformation apparatus according to the present invention;

an image synthesis processing unit for creating a combined image data by combining the camera image data and the coordinate-converted map image data with each other or combining the coordinate-converted camera image data and the map image data with each other in the state where the point of interest coordinates of these data are arranged to correspond to each other, and

an image display processing unit for creating a display signal based on the combined image data.

According to a preferable mode of the image transformation apparatus, the coordinate conversion processing unit further reads a route guide image data positionally corresponding to the map image data from the navigation apparatus, and converts coordinates of the route guide image data so that an image of the route guide image data is transformed based on the distortion, and

the image synthesis processing unit combines the coordinate-converted route guide image data and the camera image data with each other so that an image of the transformed route guide image data positionally corresponds to an image of the untransformed camera image data.

According to another preferable mode of the image transformation apparatus, the coordinate conversion processing unit reads a map image data including a route guide image data positionally corresponding to the map image data from the navigation apparatus as the map image data, and converts coordinates of the map image data including the route guide image data so that an image of the map image data including the route guide image data is transformed based on the distortion, and the image synthesis processing unit combines the coordinate-converted map image data including the route guide image data and the camera image data with each other so that an image of the transformed map image data including the route guide image data positionally corresponds to an image of the untransformed camera image data.

According to the present invention, the route guide image data is preferably an image data indicating a destination position to which the car should be guided or an image data indicating a right direction for the destination.

According to still another preferable mode of the image transformation apparatus, the image synthesis processing unit adjusts a luminance signal or a color difference signal of a region relevant to the camera image data positionally corresponding to an image data indicating a destination position to which the car should be guided which is the coordinate-converted route guide image data, and combines the adjusted signal with the route guide image data.

### Effect of the Invention

The present invention exerts such a distinctly advantageous effect that a car driver can be accurately guided at an intersection while solving the conventional problem which is dependence on the position and optical conditions of a camera loaded in the car.

### BRIEF DESCRIPTION OF THE DRAWINGS

FIG. 1 is a block diagram illustrating a structure of a car navigation apparatus according to preferred embodiments of the present invention.

FIG. 2 is a block diagram of an image transformation apparatus according to the present invention and its peripheral devices.

FIG. 3 is an illustration of pixels for determining a contour pixel according to the present invention.

FIG. 4 is an illustration of an image obtained by a camera according to the present invention.

FIG. 5 is an illustration of an image obtained from a camera image data in which a contour component according to a preferred embodiment 1 of the present invention is detected.

FIG. 6 is an illustration of an image obtained from a camera image data in which a particular region according to the preferred embodiment 1 is displayed.

FIG. 7 is an illustration of an image obtained from a road color difference data according to the preferred embodiment 1.

FIG. 8 is an illustration of an image obtained from a recognized road image data according to the preferred embodiment 1.

FIG. 9 is an illustration of an image obtained from a map image data according to preferred embodiments 1, 4, 5, 6, 7, 8, 9 and 10 of the present invention.

FIG. 10 is an illustration of an image obtained from the camera image data according to the preferred embodiment 1 where flexion points of a road contour are determined.

FIG. 11 is an illustration of road contour vectors according to preferred embodiments 1 and 3 of the present invention.

FIG. 12 is an illustration of an image obtained from the map image data according to the preferred embodiment 1 where flexion points of a road contour are determined.

FIG. 13 is an illustration of an image obtained from a camera image data according to a preferred embodiment 2 of the present invention where flexion points of a road contour are determined.

FIG. 14 is an illustration of road contour vectors in the camera image data according to preferred embodiment 2.

FIG. 15 is an illustration of road contour vectors in a camera image data according to a preferred embodiment 3 of the present invention.

FIG. 16 is an illustration of a coordinate conversion image according to the preferred embodiments 4, 5 and 6.

FIG. 17 is an illustration of an image obtained from image transformation of a map image data according to the preferred embodiments 4 and 5.

FIG. 18 is an illustration of an image obtained from image transformation of a camera image data according to the preferred embodiments 4 and 5.

FIG. 19 is an illustration of road contour vectors according to the preferred embodiment 5.

FIG. 20 is an illustration of an image obtained from a route guide arrow image data according to the preferred embodiment 6.

FIG. 21 is an illustration of an image obtained from image transformation of a route guide arrow image data according to the preferred embodiment 6.

FIG. 22 is an illustration of an image obtained from a combined image in which a route guide arrow image data according to the preferred embodiment 6 is combined with a camera image data.

FIG. 23 is an illustration of an image obtained from a map image data including a route guide arrow image data according to the preferred embodiment 7.

FIG. 24 is an illustration of an image obtained from image transformation of the map image data including the route guide arrow image data according to the preferred embodiment 7.

FIG. 25 is an illustration of an image obtained from a combined image in which the map image data including the route guide arrow image data according to the preferred embodiment 7 is combined with camera image data.

FIG. 26 is an illustration of an image obtained from a destination mark image data according to preferred embodiments 8, 9 and 10 of the present invention.

FIG. 27 is an illustration of an image obtained from image transformation of the destination mark image data according to the preferred embodiments 8 and 10.

FIG. 28 is an illustration of an image obtained from a combined image in which the destination mark image data according to the preferred embodiments 8 and 9 is combined with camera image data.

FIG. 29 is an illustration of an image obtained from a map image data including a destination mark image data according to the preferred embodiment 9.

FIG. 30 is an illustration of an image obtained from image transformation of the map image data including the destination mark image data according to the preferred embodiment 9.

FIG. 31 is an illustration of an image obtained from a combined image in which the map image data including the destination mark image data according to the preferred embodiments 8 and 9 is combined with camera image data.

FIG. 32 is an illustration of an image where a contour of a destination building according to the preferred embodiment 10 is changed.

FIG. 33 is an illustration of an image where a color difference information of the building according to the preferred embodiment 10 is changed.

FIG. 34 is a flow chart illustrating an image transformation method according to the preferred embodiments 1, 2, 3, 4 and 5.

FIG. 35 is a flow chart illustrating an image display method according to the preferred embodiments 6 and 7.

FIG. 36 is a flow chart illustrating an image display method according to the preferred embodiments 8, 9 and 10.

### DESCRIPTION OF REFERENCE SYMBOLS

101 communication control unit
102 self-contained navigation control unit
103 GPS control unit
104 VICS information receiver
105 audio output unit
106 navigation control unit
107 map information database
108 updated information database
109 imaging unit
110 image processing unit
111 image synthesis processing unit
112 image display processing unit
113 selector
202 luminance signal/color difference signal division processing unit
203 luminance signal processing unit
204 color difference signal processing unit
205 image recognition unit
206 point of interest coordinate detection unit
207 selector
208 coordinate conversion processing unit

### BEST MODE FOR CARRYING OUT THE INVENTION

Hereinafter, preferred embodiments of the present invention are described in detail referring to the drawings. In the preferred embodiments of the present invention, hardware and software are variously changed and used. In the description given below, therefore, virtual block diagrams for accomplishing functions according to the present invention and its preferred embodiments are used. The preferred embodiments described below do not limit the inventions recited in the Scope of Claims, and all of the combinations of technical features described in the preferred embodiments are not required to embody the invention.

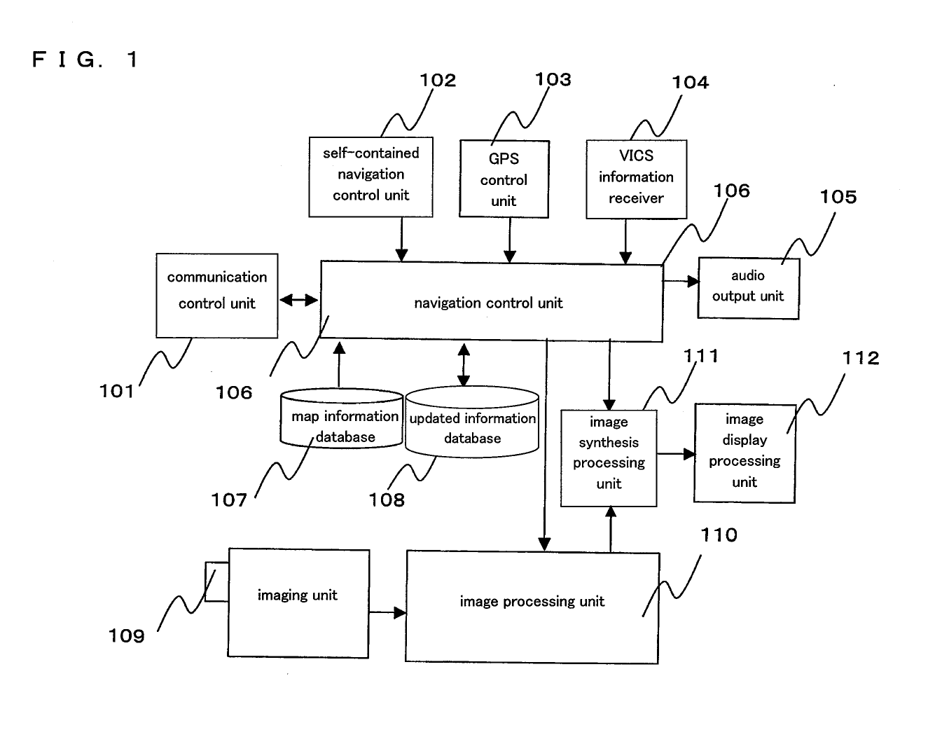

A car navigation apparatus according to the present invention is a route guiding apparatus, wherein a route for arriving at a destination preset by a user is searched and set based on a preinstalled road map image data so that the user is guided to the destination on the route. The apparatus has structural elements illustrated in the functional block diagram of FIG. 1. FIG. 1 illustrates a structure of a car navigation apparatus according to each preferred embodiment of the present invention.

A self-contained navigation control unit 102 detects a car speed sensor which detects a travelling speed of a car equipped with the car navigation apparatus, and a rotational angle of the car. According to the self-contained navigation, a present location cursor is activated by just a signal that can be detected from the car.

A global positioning system controller (hereinafter, simply called GPS control unit) 103 receives a GPS signal transmitted from a plurality of artificial satellites (GPS satellites) travelling along a predetermined orbit approximately 20,000 km above the earth through a GPS receiver, and measures a present location and a present azimuth of the car by using information included in the GPS signal.

A vehicle information and communication system information receiver (hereinafter, simply called VICS information receiver) 104 successively receives through its external antenna information of current traffic situations on roads in the surroundings of the car transmitted by a VICS center. The VICS is a system that receives traffic information transmitted through FM multiplex broadcasting or a road transmitter and displays the information in graphic or text. The VICS center transmits in real time the road traffic information edited and variously processed (traffic jam, traffic control). The car navigation system receives the road traffic information through the VICS information receiver 104, and then superposes the received road traffic information on a preinstalled map for display.

A communication control unit 101 can communicate data wirelessly or via a cable. A communication apparatus to be controlled by the communication control unit 101 (not shown) may be a built-in device of the car navigation apparatus, or a mobile communication terminal, such as a mobile telephone, may be externally connected to the apparatus. A user can access an external server via the communication control unit 101. A navigation control unit 106 is a device for controlling the whole apparatus.

A map information database 107 is a memory necessary for the operation of the apparatus where various types of data such as a recorded map image data and facility data are stored. The navigation control unit 106 reads a required map image data from the map information database 17. The memory in the map information database 107 may be in the form of CD/DVD-ROM or hard disc drive (HDD).

An updated information database 108 is a memory used for the storage of a differential data of the map information updated by the map information database 107. The storage of the updated information database 108 is controlled by the navigation control unit 106.

An audio output unit 105 includes a speaker to output, for example, a voice or sound which, for example, informs the driver of an intersection during route guidance. An imaging unit 109 is a camera set in a front section of the car and equipped with an imaging element such as a CCD sensor or a CMOS sensor. An image processing unit 110 converts an electrical signal from the imaging unit 109 into an image data and processes the map image data from the navigation control unit 106 into an image. An image synthesis processing unit 111 combines the map image data obtained at a present position of the car inputted from the navigation control unit 106 with a camera image data inputted from the image processing unit 110. An image display processing unit 112 displays an image of the combined image data obtained by the image synthesis processing unit 111 on a display of the car navigation apparatus.

### Preferred Embodiment 1

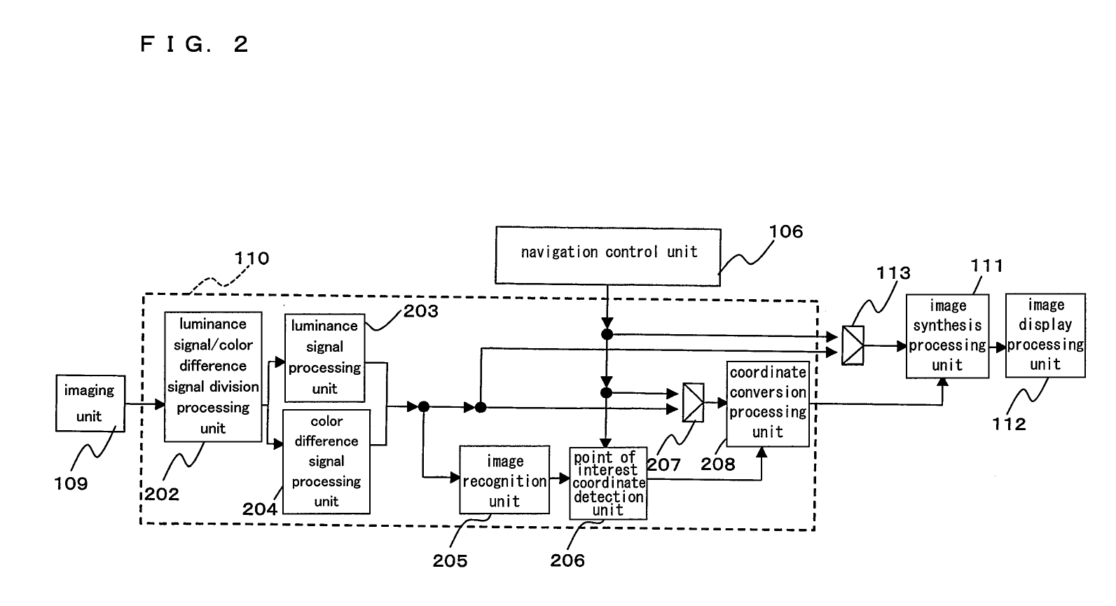

An image transformation method and an image transformation apparatus according to a preferred embodiment 1 of the present invention are described below referring to FIGS. 1-12 and 34. FIG. 2 is a block diagram illustrating the image transformation apparatus and its peripheral devices. The same structural components as those illustrated in FIG. 1 are given the same reference symbols.

Referring to FIG. 2, the image processing unit 110 has an image recognition unit 205 which recognizes a road shape in the camera image data (image of the surroundings of a car equipped with the car navigation apparatus) of the imaging unit 109 which obtains surrounding images from the car, a point of interest coordinate detection unit 206 which reads a map image data from the navigation apparatus indicating the car's present position and detects point of interest coordinates from the camera image data and the map image data, and a coordinate conversion processing unit 208. The image recognition unit 205, point of interest coordinate detection unit 206 and coordinate conversion processing unit 208 constitute the image transformation apparatus. The image transformation apparatus exerts a function in a basic image processing of the image processing unit 110 illustrated in FIG. 1.

The image processing unit 110 further has a luminance signal/color difference signal division processing unit 202 which divides an imaging signal from the imaging unit 109 into a luminance signal and a color difference signal, a luminance signal processing unit 203 which processes the luminance signal outputted from the luminance signal/color difference signal division processing unit 202, and a color difference signal processing unit 204 which processes the color difference signal outputted from the luminance signal/color difference signal division processing unit 202. The image recognition unit 205 executes an image recognition processing based on the signals separately processed by the luminance signal processing unit 203 and the color difference signal processing unit 204.

The camera image data is inputted to the luminance signal/color difference signal division processing unit 202 from the imaging unit 109. When three-color data containing red (R), green (G) and blue (B) (three primary colors of light) is inputted from the imaging unit 109 to the luminance signal/color difference signal division processing unit 202, the luminance signal/color difference signal division processing unit 202 converts the RGB three-color data into a Y signal, a U signal and a V signal based on the following conventional color space conversion formulas.

Y=0.29891×R+0.58661×G+0.11448×B

U=−0.16874×R−0.33126×G+0.50000×B

V=0.50000×R−0.41869×G−0.08131×B

Further, the luminance signal/color difference signal division processing unit 202 may convert the RGB three-color data inputted from the imaging unit 109 into a Y signal, a Cb signal and a Cr signal based on the following YCbCr color space conversion formulas defined by ITR-R BT.601.

Y=0.257R+0.504G+0.098B+16

Cb=−0.148R−0.291G+0.439B+128

Cr=0.439R−0.368G−0.071B+128

The Y signal denotes a luminance signal (luminance), the Cb signal and U signal denote a difference signal of blue (color difference signals), and the Cr signal and V signal denote a difference signal of red.

When three-color data containing cyan (C), magenta (M) and yellow (Y) (three primary colors of colorant) is inputted from the imaging unit 109 to the luminance signal/color difference signal division processing unit 202, the luminance signal/color difference signal division processing unit 202 converts the CMY three-color data into RGB three-color data based on the following formulas, and converts the post-conversion data into a Y signal, a Cb signal and a Cr signal (Y signal, U signal and V signal) by choosing any of the color space conversion formulas mentioned earlier, and then outputs the obtained signals.

R=1.0−C

G=1.0−M

B=1.0−Y

In the case where the Y signal, U signal and V signal are structurally inputted from the imaging unit 109, the luminance signal/color difference signal division processing unit 202 just divides the inputted signals without any particular signal conversion.

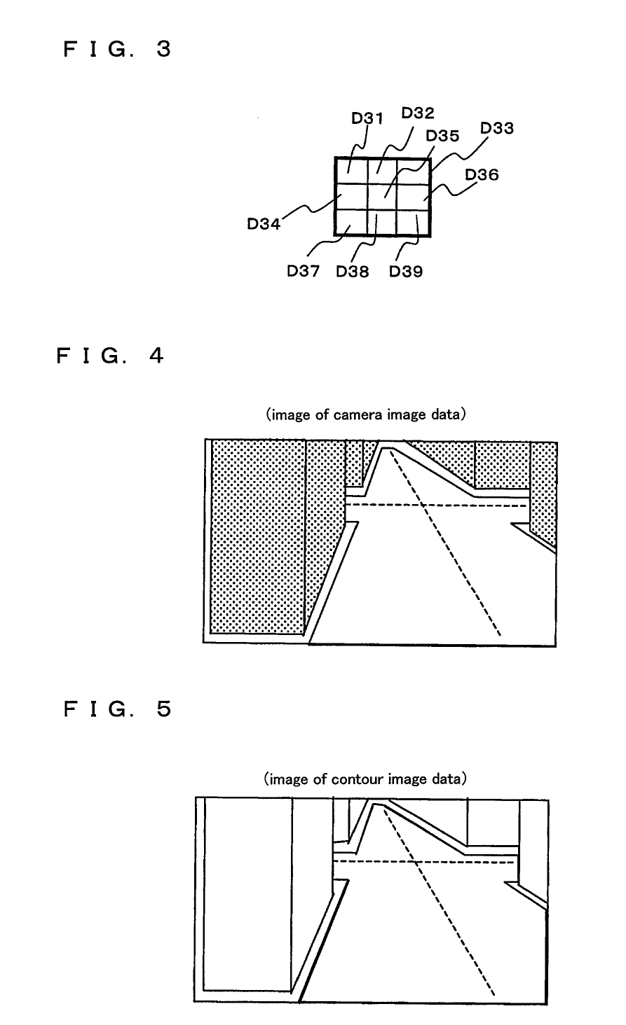

The luminance signal processing unit 203 provides signal processing to the luminance signal inputted from the luminance signal/color difference signal division processing unit 202 depending on its luminance level. The luminance signal processing unit 203 then determines a contour pixel. When a contour pixel is determined in such simple peripheral pixels as 3×3 pixels illustrated in FIG. 3, for example, luminance signals of pixels D31-D34 and D36-D39 in the periphery of a particular pixel D35 are compared to a luminance signal of the particular pixel D35. In the case where the inter-signal differences in luminance are larger than a given value, it is determined that a contour is present between the particular pixel D35 and its peripheral pixels, and the particular pixel D35 is determined as the contour pixel. More specifically, when a camera image data, whose image is illustrated in FIG. 4, is inputted, a contour image data, whose image is illustrated in FIG. 5, is created as an image data in which a contour component is detected based on luminance information.

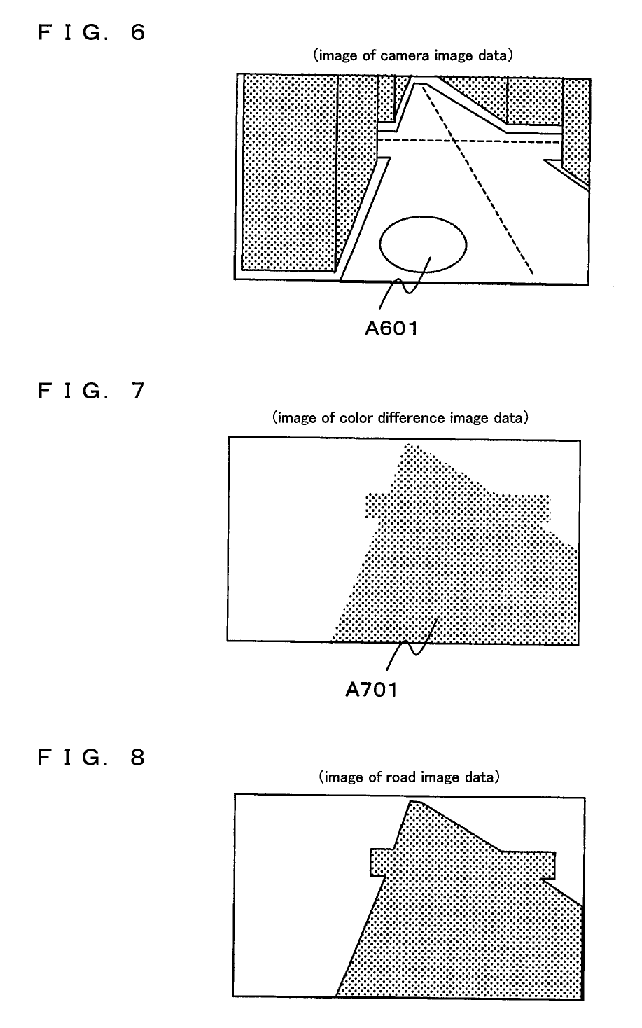

The color difference signal processing unit 204 provides signal processing to the color difference signal inputted from the luminance signal/color difference signal division processing unit 202 depending on its color difference level. The color difference signal processing unit 204 compares color difference information of each pixel to color difference information of pixels in a particular image region (first image region) (hereinafter, called particular region pixels), and determines an image region (second image region) consisting of pixels having color difference information equal to that of the particular region pixels. The camera is conventionally set at the center of the car and trained ahead. In this case, the road is located at a lower-side center of the camera image, which means that the car is definitely on the road. Therefore, the color difference signal of the road during travelling can be recognized by setting the particular image region (first image region) at the lower-side center of the obtained image, as exemplified by an image region A601 in the camera image data whose image is illustrated in FIG. 6. Accordingly, only the color difference image data of an image region A701 regarded as a road can be extracted as illustrated in FIG. 7 by extracting the pixels having the color difference signals equal to those of the preset particular image region in the camera image data.

The image recognition unit 205 is supplied with the contour image data (an image of which is illustrated in FIG. 5) from the luminance signal processing unit 203 and the color difference image data of the image region A701 regarded as a road (an image of which is illustrated in FIG. 7) from the color difference signal processing unit 204. The image recognition unit 205 extracts only the contour pixel data of the road region from the supplied image data and combines the extracted contour pixel data of the road region, and then outputs the image data of the image region (second image region), an image of which is illustrated in FIG. 8. More specifically, the image recognition unit 205 recognizes a contour component image signal at a position adjacent to the image region regarded as a road (color difference image data A701) or a position similar to the adjacent position so as to extract the road contour pixel data alone. The image recognition unit 205 further recognizes the image data of the image region obtained by combining the extracted road contour pixel data and outputs the recognized image data of the image region (an image of which is illustrated in FIG. 8). According to the structures described so far, the road shape (road contour) can be recognized based on the camera image data obtained from the car.

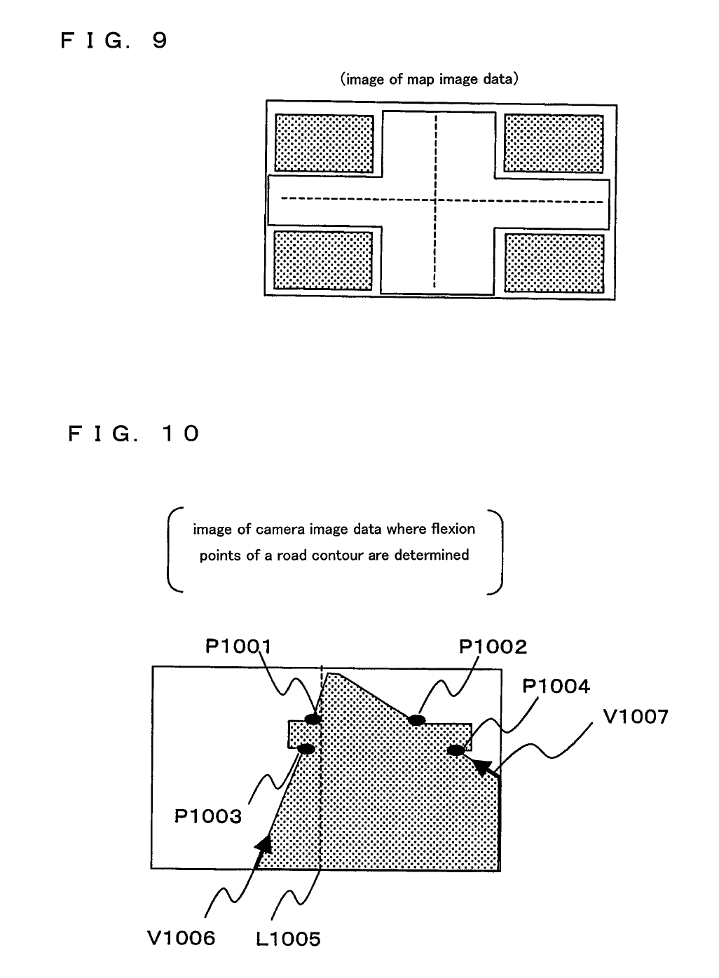

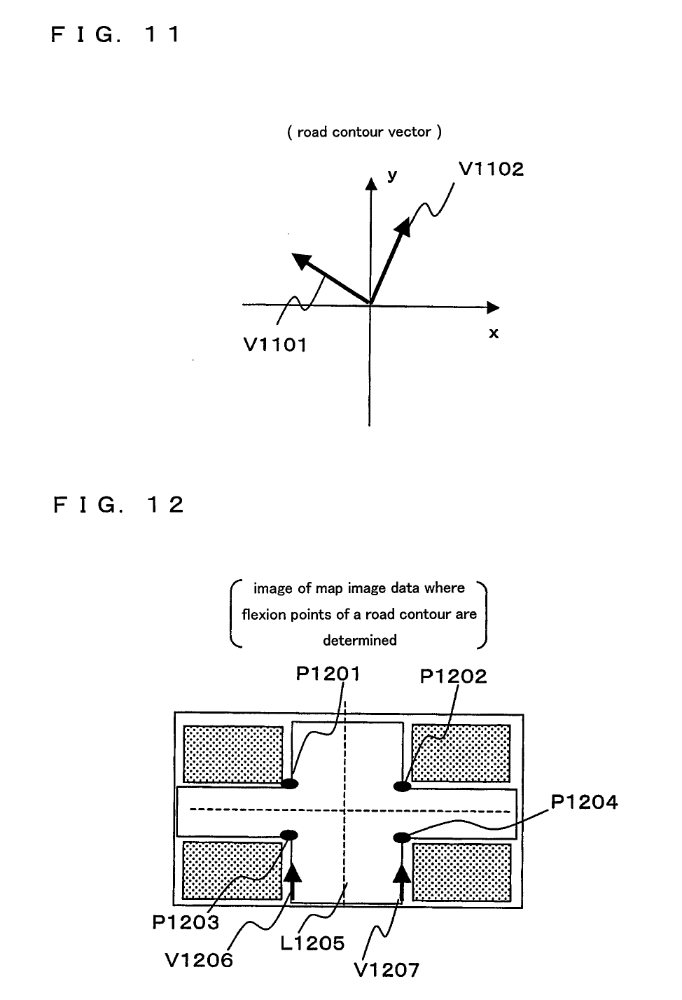

The point of interest coordinate detection unit 206 is supplied with a road image data (image data of the second image region) from the image recognition unit 205 and a map image data (an image of which is illustrated in FIG. 9) from the navigation control unit 106. The point of interest coordinate detection unit 206 calculates flexion points of a road contour (road contour flexion points) in an image region regarded as a road, and detects relevant coordinates P1001-P1004 as point of interest coordinates (more specifically, intersection contour coordinates). The points of interest (coordinates P1001-P1004) are illustrated in FIG. 10.

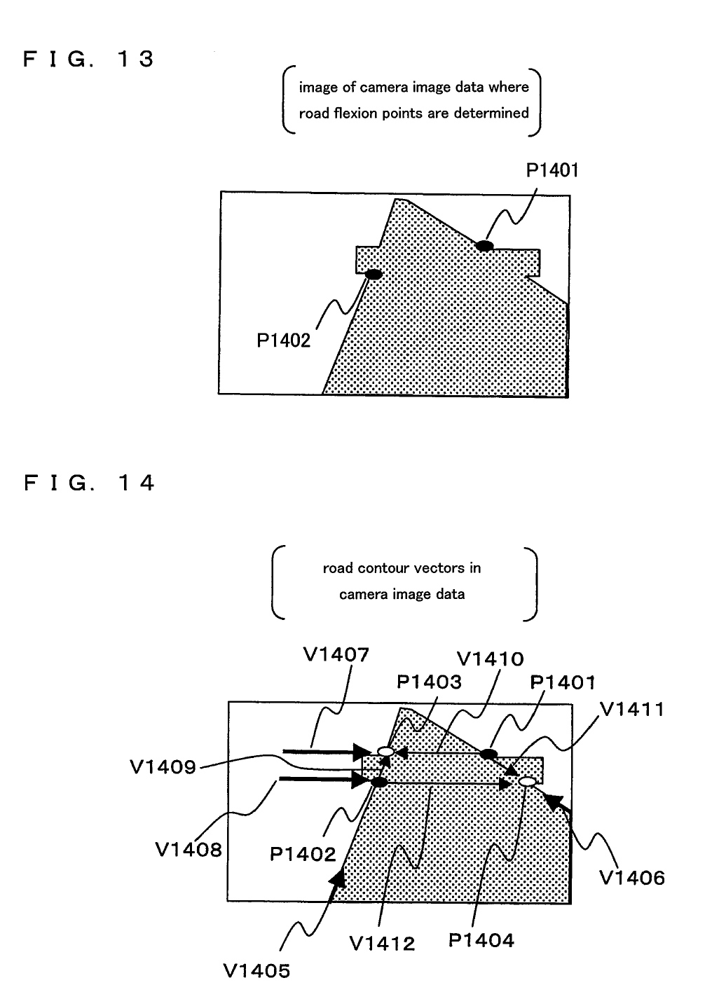

Next, processing steps for calculating the road contour flexion point by the point of interest coordinate detection unit 206 are specifically described below. As illustrated in FIG. 10, an image region regarded as a road region in the camera image data is divided laterally on a screen by a vertical base line L1005 drawn at the screen center. Then, a road contour vector V1006 on the left-side screen and a road contour vector V1007 on the right-side screen are calculated. In the image region regarded as a road region, the road contour vector V1006 on the left-side screen is limited to a direction vector of first quadrant (which is V1102 illustrated in FIG. 11), and the road contour vector V1007 on the right-side screen is limited to a direction vector of second quadrant (which is V1101 illustrated in FIG. 11) according to the law of perspective, based on which the road contour vectors V1006 and V1007 are detected. The direction vector can be detected by calculating a linear approximate line with respect to pixels of the road contour. The coordinates of the flexion points in the road contour along the detected left-side road contour vector V1006 and the detected right-side road contour vector V1007 are calculated as point of interest coordinates. The perspective in this description is linear perspective, which is a technique where a vanishing point is created so that all of objects focus on one spot. The point of interest coordinate detection unit 206 similarly calculates the road contour flexion points in a map image data illustrated in FIG. 9, and detects coordinates P1201-P1204 relevant to the road contour flexion points as the point of interest coordinates (more specifically, intersection) as illustrated in FIG. 12.

Summarizing the description, according to the method for calculating the road contour flexion point:
1) the map image data (FIG. 9) is divided laterally on the screen by the vertical base line L1205 as illustrated in FIG. 12;
2) the right-side and the left-side road contour vector V1206 and V1207 are calculated. The direction vector V1206 is limited to a direction vector of first quadrant as illustrated by V1102 in FIG. 11, and the direction vector V1207 is limited to a direction vector of second quadrant as illustrated by the direction vector V1101 in FIG. 11;
3) the coordinates of the flexion points in the road contour along the road contour vectors V1206 and V1207 are calculated as the points of interest (point of interest coordinates); and
4) the point of interest coordinates in the camera image (FIG. 6) and the map image (FIG. 9) are outputted.

The description was given so far referring to the two-dimensional map image data. The points of interest can be calculated in three-dimensional map image data as well in similar processing.

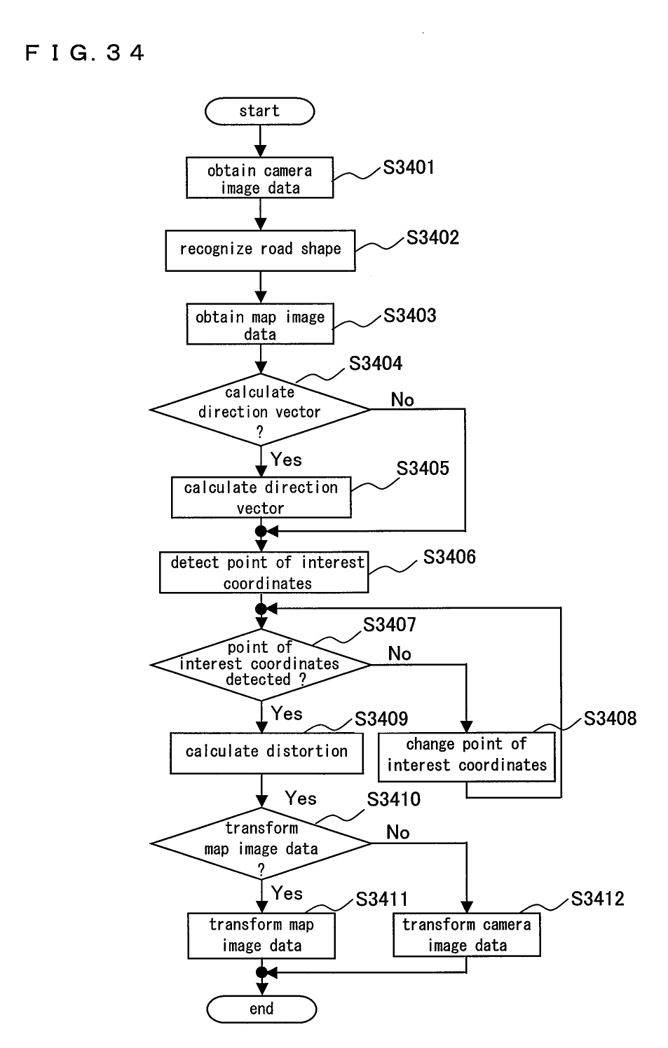

In view of the structural concept described so far, the image transformation method according to the preferred embodiment 1 is described below referring to a flow chart illustrated in FIG. 34. In Step S3401, the image processing unit 110 obtains the camera image data (FIG. 4) from the imaging unit 109. In Step S3402, the luminance signal/color difference signal division processing unit 202, luminance signal processing unit 203, color difference signal processing unit 204 and image recognition unit 205 recognize the road shape (road contour) based on the camera image data (FIG. 4) obtained by the image processing unit 110.

In Step S3403, the point of interest coordinate detection unit 206 obtains the map image data (FIG. 9) from the navigation control unit 106. In Step S3404, the point of interest coordinate detection unit 206 determines whether to calculate the direction vector or not. It is unnecessary to calculate the direction vector in the method according to the present preferred embodiment. Therefore, it is determined in Step S3404 that the direction vector is not calculated. The processing accordingly skips Step S3405 and proceeds to Step S3406. In Step S3406, the point of interest coordinate detection unit 206 detects the intersection contour coordinates as the point of interest coordinates.

According to the method and structure described so far, the flexion point coordinates of the road contour in the camera image data (FIG. 4) generated by the imaging unit 109 are detected as the point of interest coordinates P1001-P1004 (intersection contour coordinates). Further, the flexion point coordinates of the map contour in the map image data (FIG. 9) of the navigation apparatus (navigation control unit 106) are detected as the point of interest coordinates P1001-P1004 (intersection contour coordinates) and the point of interest coordinates P1201-P1204 (intersection contour coordinates). The flexion point coordinates of the map contour in the map image data are detected such that they are arranged to correspond with the flexion point coordinates of the map contour in the camera image data.

### Preferred Embodiment 2

An image transformation method and an image transformation apparatus according to a preferred embodiment 2 of the present invention are described referring to FIGS. 1, 2, 13, 14 and 34. The present preferred embodiment is structurally similar to the preferred embodiment 1, however, includes the following differences.

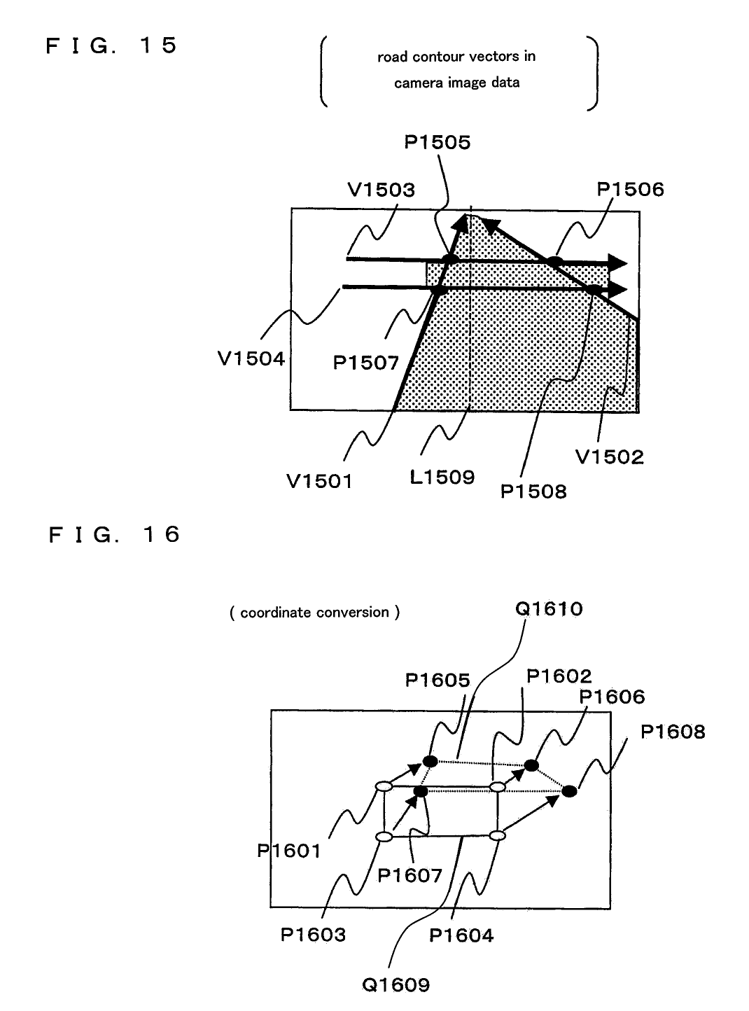

In the preferred embodiment 1, the point of interest coordinate detection unit 206 does not detect the point of interest coordinates (intersection contour coordinates) in the camera image data in the case where there is any other car or obstacle at the point of interest to be calculated in the camera image data. In FIG. 13, for example, of all of the point of interest coordinates (intersection contour coordinates) necessary for identifying the intersection in the camera image data, only a part of the point of interest coordinates, which are P1401 and P1042, are detected (hereinafter, called detected point of interest coordinates), whereas the other point of interest coordinates (hereinafter, called residual point of interest coordinates), P1403 and P1404, are left out of the selection.

In this case, the residual point of interest coordinates P1403 are calculated (estimated) based on road contour vectors V1405-1408, detected point of interest coordinates P1401 and P1402, and direction vectors V1409 and V1410 according to the present preferred embodiment. Similarly, the residual point of interest coordinates P1404 are calculated (estimated) based on the road contour vectors V1405-1408, detected point of interest coordinates P1401 and P1402, and direction vectors V1411 and V1412. The residual point of interest coordinates P1403 and P1404 in the camera data thus calculated are added to the detected point of interest coordinates P1401 and P1402 calculated earlier. In the present preferred embodiment, such a calculation (estimation) and addition of the point of interest coordinates are called a change of the point of interest coordinates.

The point of interest coordinates in the camera image data obtained by the change of the point of interest coordinates are outputted from the point of interest coordinate detection unit 206. The direction vector V1410 is reverse to the road contour vector V1407, and the direction vector V1411 is reverse to the road contour vector V1406 because the reverse directions vectors are selectively used to calculate the left-out point of interest coordinates P1403 and P1404.

In view of the structural concept described so far, the image transformation method according to the preferred embodiment 2 is described below referring to the flow chart illustrated in FIG. 34. In Step S3401, the image processing unit 110 obtains the camera image data (FIG. 4) from the imaging unit 109. In Step S3402, the luminance signal/color difference signal division processing unit 202, luminance signal processing unit 203, color difference signal processing unit 204 and image recognition unit 205 recognize the road shape (road contour) based on the camera image data (FIG. 4) obtained by the image processing unit 110.

In Step S3403, the point of interest coordinate detection unit 206 obtains the map image data (FIG. 9) from the navigation control unit 106. In Step S3404, the point of interest coordinate detection unit 206 determines whether to calculate the direction vector or not. It is unnecessary to calculate the direction vector in the method according to the present preferred embodiment. Therefore, it is determined in Step S3404 that the direction vector is not calculated. The processing accordingly skips Step S3405 and proceeds to Step S3406. In Step S3406, the point of interest coordinate detection unit 206 detects the point of interest coordinates as the intersection contour coordinates.

In the case where the point of interest coordinate detection unit 206 fails in Step S3407 to detect all of the point of interest coordinates necessary for identifying the intersection, the point of interest coordinate detection 206 changes the point of interest coordinates (calculates (estimates) the undetected point of interest coordinates) in Step S3408.

According to the method and structure described so far, the point of interest coordinates can be changed (undetected point of interest coordinates can be calculated (estimated)) based on the detected point of interest coordinates even in the case where some of the point of interest coordinates are not detected due to the presence of any other vehicle or obstacle.

### Preferred Embodiment 3

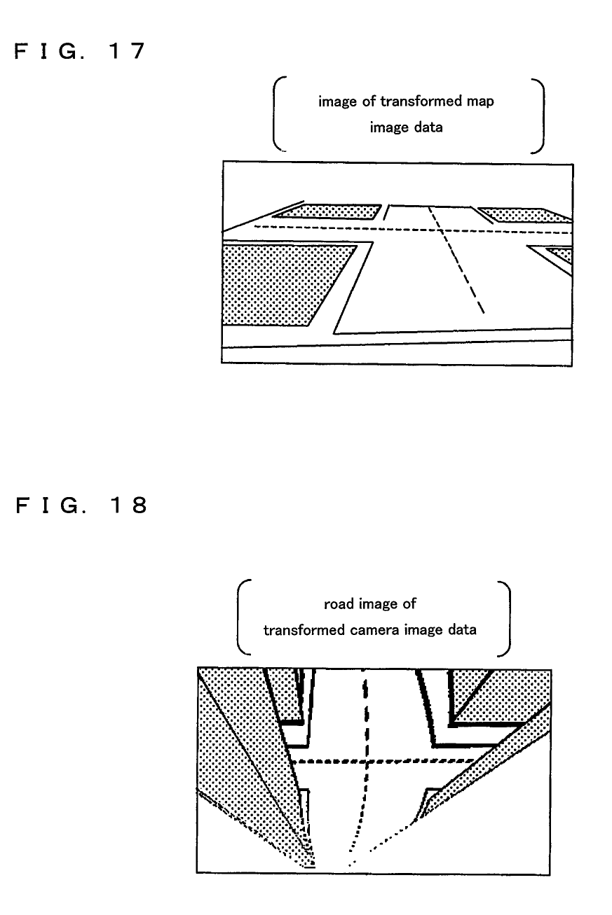

An image transformation method and an image transformation apparatus according to a preferred embodiment 3 of the present invention are described referring to FIGS. 1, 2, 11, 15 and 34. The present preferred embodiment is structurally similar to the preferred embodiment 1, however, includes the following differences.

In the present preferred embodiment, the point of interest coordinate detection unit 206 calculates road contour vectors V1501-V1504 in the camera image data, and then calculates intersection coordinates P1505-P1508 of the calculated road contour vectors V1501-V1504. The point of interest coordinate detection unit 206 detects the calculated intersection coordinates P1505-P1508 as the point of interest coordinates (intersection contour coordinates).

Next, processing steps for calculating the intersection coordinates P1505-P1508 of the road contour vectors V1501-V1504 are specifically described. First, the processing steps for calculating the road contour vectors V1501-V1504 are described. In the description given below, the camera is set toward a direction in which the car equipped with the car navigation system is heading (the camera is usually thus set).

A base line L1509 is set at a center position of the camera image data in its lateral width direction, and the road contour vectors L1501-L1504 are then calculated from the camera image data. Then, the road contour vector which meets the following requirements is detected from the direction vectors V1501-V1504 as a left-side contour vector V1501 of the road where the car is heading.
the vector is located on the left side of the base line L1509, and
the vector is a direction vector of first quadrant.

Based on the law of perspective, the left-side contour vector of the road where the car is heading should be limited to a direction vector of first quadrant (see V1102 illustrated in FIG. 11). To detect the left-side contour vector of the road where the car is heading, the direction vector to be detected is limited to a direction vector of first quadrant.

Similarly, the road contour vector which meets the following requirements is detected as a right-side contour vector V1502 of the road where the car is heading.
the vector is located on the right side of the base line L1509, and
the vector is a direction vector of second quadrant.

Based on the law of perspective, the right-side contour vector of the road where the car is heading should be limited to a direction vector of second quadrant (see V1101 illustrated in FIG. 11). To detect the contour vector on the right side of the right-side contour vector of the road where the car is heading, the direction vector to be detected is limited to a direction vector of second quadrant.

Apart from the road contour vectors V1501 and V1502, road contour vectors V1503 and V1504 of a road crossing the road where the car is heading (hereinafter, called a crossing road) are detected. The road contour vectors V1503 and V1504 are direction vectors intersecting with the left-side contour vector V1501 of the road where the car is heading and the right-side contour vector V1502 of the road where the car is heading.

Then, intersecting coordinates in the road contour vectors V1501-V1504 thus selected are regarded as coordinates indicating the contour of the intersection (intersection contour coordinates), and the coordinates are detected as the point of interest coordinates.

Then, road contour vectors V1501′-V1504′ and relevant point of interest coordinates are similarly calculated from the map image data.

The point of interest coordinates thus calculated in the camera image data and the map image data and the road contour vectors are arranged to correspond with each other, and then outputted from the point of interest coordinate detecting unit 206.

In view of the structural concept described so far, the image transformation method according to the preferred embodiment 3 is described below referring to the flow chart illustrated in FIG. 34. In Step S3401, the image processing unit 110 obtains the camera image data (FIG. 4) from the imaging unit 109. In Step S3402, the luminance signal/color difference signal division processing unit 202, luminance signal processing unit 203, color difference signal processing unit 204 and image recognition unit 205 recognize the road shape (road contour) based on the camera image data (FIG. 4) obtained by the image processing unit 110.

In Step S3403, the point of interest coordinate detection unit 206 obtains the map image data (FIG. 9) from the navigation control unit 106. In Step S3404, the point of interest coordinate detection unit 206 determines whether to calculate the direction vector or not. It is necessary to calculate the direction vector in the method according to the present preferred embodiment. Therefore, it is determined in Step S3404 that the direction vector is calculated, and the processing proceeds to Step S3405 and Step S3406. In Step S3405, the point of interest coordinate detection unit 206 calculates the direction vectors. In Step S3406, the point of interest coordinate detection unit 206 detects the intersection contour coordinates as the point of interest coordinates.

According to the method and structure described so far, the intersection contour coordinates can be detected as the point of interest coordinates based on the direction vectors of the road information recognized in the camera image and the direction vectors of the map image.

### Preferred Embodiment 4

An image transformation method and an image transformation apparatus according to a preferred embodiment 4 of the present invention are described referring to

FIGS. 1, 2, 16-18, and 34. The present preferred embodiment is structurally similar to the preferred embodiment 1, however, includes the following differences. In the present preferred embodiment, the image recognition unit 205, the point of interest coordinate detection unit 206, the coordinate conversion processing unit 208, and a selector 207 constitute the image transformation apparatus. The selector 207 selects images inputted to the coordinate conversion processing unit 208.

The point of interest coordinates in the camera image data and the point of interest coordinates in the map image data are directly inputted from the point of interest coordinate detection unit 206 to the coordinate conversion processing unit 208. The camera image data (generated by the luminance signal processing unit 203 and the color signal processing unit 204) and the map image data (read by the navigation control unit 106 from the map information database 107 and the updated information database 108) are inputted to the coordinate conversion processing unit 208. The camera image data and the map image data are supplied to the coordinate conversion processing unit 208, being successively changed as the car is heading. The selector 207 is in charge of changing (selecting) the map image data.

The coordinate conversion processing unit 208 is supplied with point of interest coordinates P1601-P1604 in the map image data (see white circles illustrated in FIG. 16), and point of interest coordinates P1605-P1608 in the camera image data (see black circles illustrated in FIG. 16) from the point of interest coordinate detection unit 206. The coordinate conversion processing unit 208 recognizes that the point of interest coordinates P1601 and the point of interest coordinates P1605 correspond to each other, the point of interest coordinates P1602 and the point of interest coordinates P1606 correspond to each other, the point of interest coordinates P1603 and the point of interest coordinates P1607 correspond to each other, and the point of interest coordinates P1604 and the point of interest coordinates P1608 correspond to each other. Then, the coordinate conversion processing unit 208 calculates distortions of the respective coordinates so that the point of interest coordinates corresponding to each other can correspond with each other. The coordinate conversion processing unit 208 implements the coordinate conversion to the map image data inputted from the navigation control unit 106 via the selector 207 based on the coordinate distortions calculated beforehand, so that the images of the map image data and the camera image data are transformed.

Examples of the image transformation are bilinear interpolation often used to enlarge and reduce an image (linear density interpolation using density values of four surrounding pixels depending on their coordinates), bicubic interpolation which is an extension of the linear interpolation (interpolation using density values of 16 surrounding pixels based on cubic function), and a technique for conversion to any discretionary quadrangle.

In FIG. 16, the point of interest coordinates P1601-P1604 on the map image data and the point of interest coordinates P1605-P1608 on the camera image data are connected with each other with dotted lines so that quadrangles Q1609 and Q1610 are illustrated. The illustration, however, was provided to help the quadrangular image transformation be easily understood, and is not essential for calculating the distortions.

In view of the structural concept described so far, the image transformation method according to the preferred embodiment 4 is described below referring to the flow chart illustrated in FIG. 34. In Step S3401, the image processing unit 110 obtains the camera image data from the imaging unit 109. In Step S3402, the luminance signal/color difference signal division processing unit 202, luminance signal processing unit 203, color difference signal processing unit 204 and image recognition unit 205 recognize the road contour based on the camera image data (FIG. 4) obtained by the image processing unit 110.

In Step S3403, the point of interest coordinate detection unit 206 obtains the map image data (FIG. 9) from the navigation control unit 106. In Step S3404, the point of interest coordinate detection unit 206 determines whether to calculate the direction vector or not. It is unnecessary to calculate the direction vector in the method according to the present preferred embodiment. Therefore, it is determined in Step S3404 that the direction vector is not calculated. The processing accordingly skips Step S3405 and proceeds to Step S3406. In Step S3406, the point of interest coordinate detection unit 206 detects the point of interest coordinates representing an intersection.

In the case where the point of interest coordinate detection unit 206 fails in Step S3407 to detect all of the point of interest coordinates necessary for identifying the intersection, the point of interest coordinate detection unit 206 changes the point of interest coordinates (calculates (estimates) the undetected point of interest coordinates) in Step S3408. In Step S3409, the coordinate conversion processing unit 208 calculates the coordinate distortions. In Step S3410, the coordinate conversion processing unit 208 determines the image data to be image-transformed. In Step S3411 or S3412, the coordinate conversion processing unit 208 transforms the image data to be transformed (camera image data or map image data).

According to the structure and the method described so far, the coordinate conversion processing unit 208 calculates the distortions so that the point of interest coordinates on the map image data and the point of interest coordinates on the camera image data can correspond with each other, and then transforms the map image data by converting the coordinates depending on their calculated distortions.

FIG. 17 illustrates an image of a transformed image data obtained by transforming the map image data (see FIG. 9) corresponding to the camera image data having the distortions illustrated in FIG. 16.

When the image transformation appropriate to the distortions is performed to the camera image data (coordinate conversion), the coordinate conversion processing unit 208 similarly performs the image transformation to the camera image data inputted via the selector 207 in reverse vector directions depending on its distortions, so that a transformed camera image data illustrated in FIG. 18 is generated from the camera image data illustrated in FIG. 4.

### Preferred Embodiment 5

An image transformation method and an image transformation apparatus according to a preferred embodiment 5 of the present invention are described referring to FIGS. 1, 2, 16-19, and 34. The present preferred embodiment is structurally similar to the preferred embodiment 4, however, includes the following differences.

The coordinate conversion processing unit 208 is supplied with the road contour vectors in the camera image data and the road contour vectors in the map image data from the point of interest coordinate detection unit 206. The coordinate conversion processing unit 208 is further supplied with the camera image data from the luminance signal processing unit 203 and the color difference signal processing unit 204, and the map image data from the navigation control unit 106. The camera image data and the map image data are alternately selected by the selector 207 and then supplied to the coordinate conversion processing unit 208.

The coordinate conversion processing unit 208 is supplied with direction vectors V1901-V1904 (dotted lines) illustrated in FIG. 19 as the road contour vectors of the image image data and direction vectors V1905-V1908 (solid lines) as the road contour vectors of the camera image data. The coordinate conversion processing unit 208 recognizes that the direction vector V1901 corresponds to the direction vector V1905, the direction vector V1902 corresponds to the direction vector V1906, the direction vector V1903 corresponds to the direction vector V1907, and the direction vector V1904 corresponds to the direction vector V1908. To combine the corresponding direction vectors, such a combination of direction vectors that their relative movement can be minimized is selected from a plurality of combinations of direction vectors. Based on positional differences between a pair of corresponding direction vectors thus selected, the coordinate conversion processing unit 208 calculates the distortions. More specifically, the distortions are calculated in the same manner as described in the preferred embodiment 4. The coordinate conversion processing unit 208 provides the image transformation processing in accordance with the calculated distortions to the road contour vectors V1901-V1904 in the map image data inputted via the selector 207. As described in the preferred embodiment 4, examples of the image transformation are bilinear interpolation often used to enlarge and reduce an image (linear interpolation), bicubic interpolation, and a technique for conversion to any discretionary quadrangle.

In view of the structural concept described so far, the image transformation method according to the preferred embodiment 5 is described below referring to the flow chart illustrated in FIG. 34. In Step S3401, the image processing unit 110 obtains the camera image data from the imaging unit 109. In Step S3402, the luminance signal/color difference signal division processing unit 202, luminance signal processing unit 203, color difference signal processing unit 204 and image recognition unit 205 recognize the road contour based on the camera image data (FIG. 4) obtained by the image processing unit 110.

In Step S3403, the point of interest coordinate detection unit 206 obtains the map image data (FIG. 9) from the navigation control unit 106. In Step S3404, the point of interest coordinate detection unit 206 determines whether to calculate the direction vector or not. It is necessary to calculate the direction vector in the method according to the present preferred embodiment. Therefore, it is determined in Step S3404 that the direction vector is calculated. The processing accordingly proceeds to Steps S3405 and S3406. In Step S3405, the point of interest coordinate detection unit 206 calculates the direction vectors. In Step S3406, the point of interest coordinate detection unit 206 detects the intersection contour coordinates as the point of interest coordinates.

In the case where the point of interest coordinate detection unit 206 fails in Step S3407 to detect all of the point of interest coordinates necessary for identifying the intersection, the point of interest coordinate detection unit 206 changes the point of interest coordinates (calculates (estimates) the undetected point of interest coordinates) in Step S3408. In Step S3409, the coordinate conversion processing unit 208 calculates the coordinate distortions. In Step S3410, the coordinate conversion processing unit 208 determines the image data to be image-transformed. In Step S3411 or S3412, the coordinate conversion processing unit 208 transforms the image data to be transformed (camera image data or map image data).

According to the structure and the method described so far, the coordinate conversion processing unit 208 calculates the distortions so that the point of interest coordinates on the map image data and the point of interest coordinates on the camera image data can correspond with each other, and then transforms the map image data by converting the coordinates depending on the calculated distortions. FIG. 17 illustrates the image of the transformed image data obtained by transforming the map image data (see FIG. 9) corresponding to the camera image data having the distortions illustrated in FIG. 16.

When the image transformation appropriate to the distortions is performed to the camera image data, the coordinate conversion processing unit 208 performs the image transformation to the camera image data inputted via the selector 207 in reverse vector directions depending on the distortions, so that the transformed camera image data illustrated in FIG. 18 is generated from the camera image data illustrated in FIG. 4.

### Preferred Embodiment 6

An image display method and an image display apparatus according to a preferred embodiment 6 of the present invention are described referring to FIGS. 1, 2, 20-22, and 35. The image display apparatus according to the present preferred embodiment is provided with an image transformation apparatus structurally similar to the image transformation apparatuses according to the preferred embodiments 1-5, image synthesis processing unit 111, and image display processing unit 112.

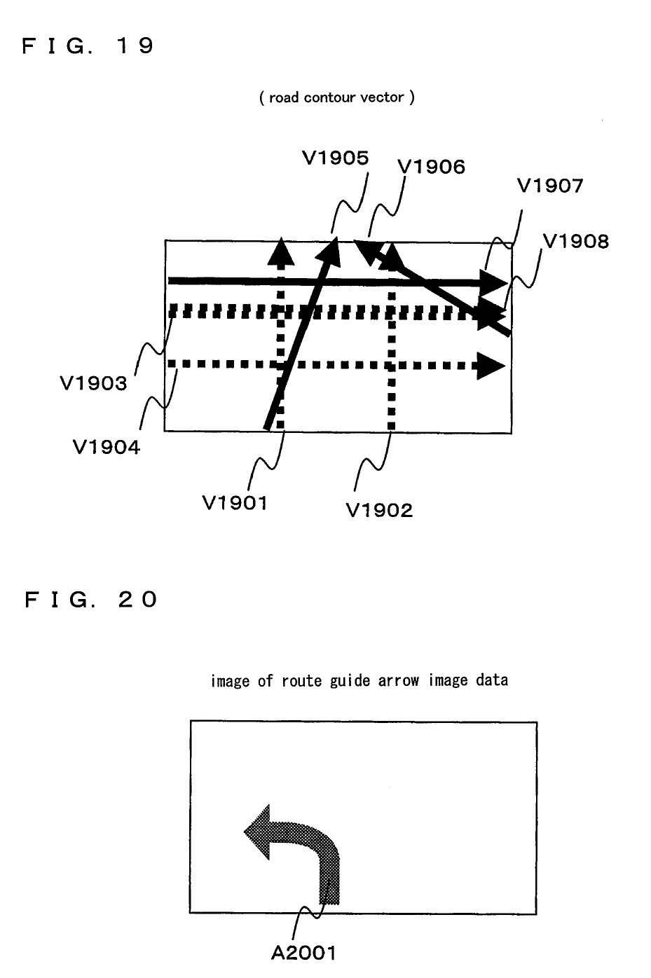

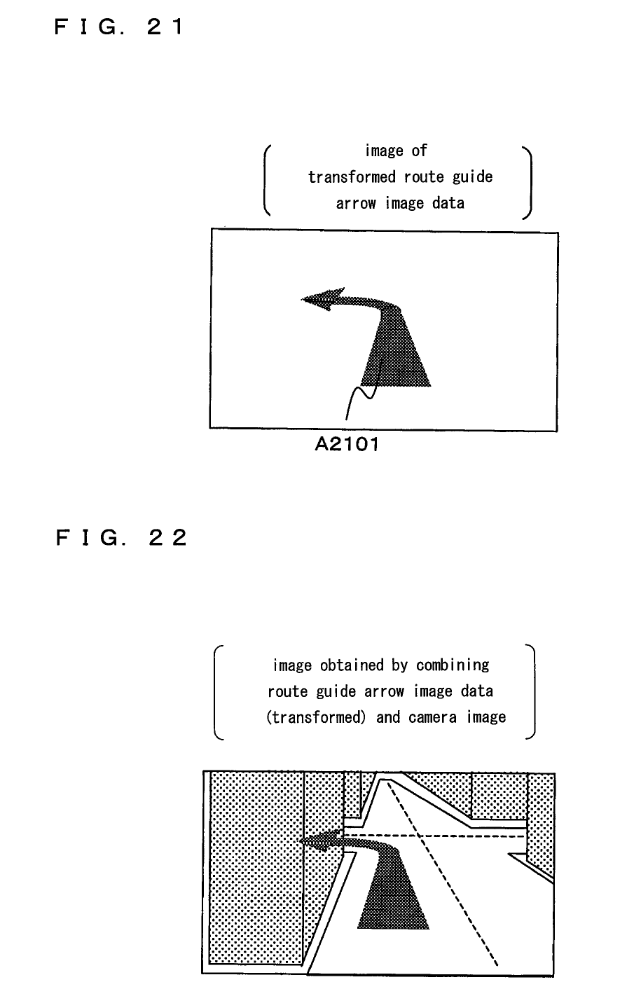

The coordinate conversion processing unit 208 reads a route guide arrow image data which is an example of the route guide image data from the navigation control unit 106, and combines the read route guide arrow image data with the map image data. For example, when the map image data illustrated in FIG. 9 is combined with a route guide arrow image data A2001 illustrated in FIG. 20, the car can be guided at an intersection. The coordinate conversion processing unit 208 carries out the image transformation described in the preferred embodiments 1-5 to the route guide arrow data A2001 to generate a route guide arrow image data (transformed) A2101 whose image is illustrated in FIG. 21, and supplies the generated route guide arrow image data A2101 (transformed) to the image synthesis processing unit 111. The image synthesis processing unit 111 is supplied with the image-transformed route guide arrow image data (transformed) A2101, and further supplied with the camera image data via a selector 113. Taking the camera image data illustrated in FIG. 4 for instance, when the route guide arrow image data (transformed) A2101 is combined with the camera image data in such a way that their positional coordinates correspond to each other, a combined image data whose image is illustrated in FIG. 22 is obtained. The image synthesis processing unit 111 outputs the combined image data thus combined to the image display processing unit 112. The image display processing unit 112 displays an image of the inputted combined image data on a display screen.

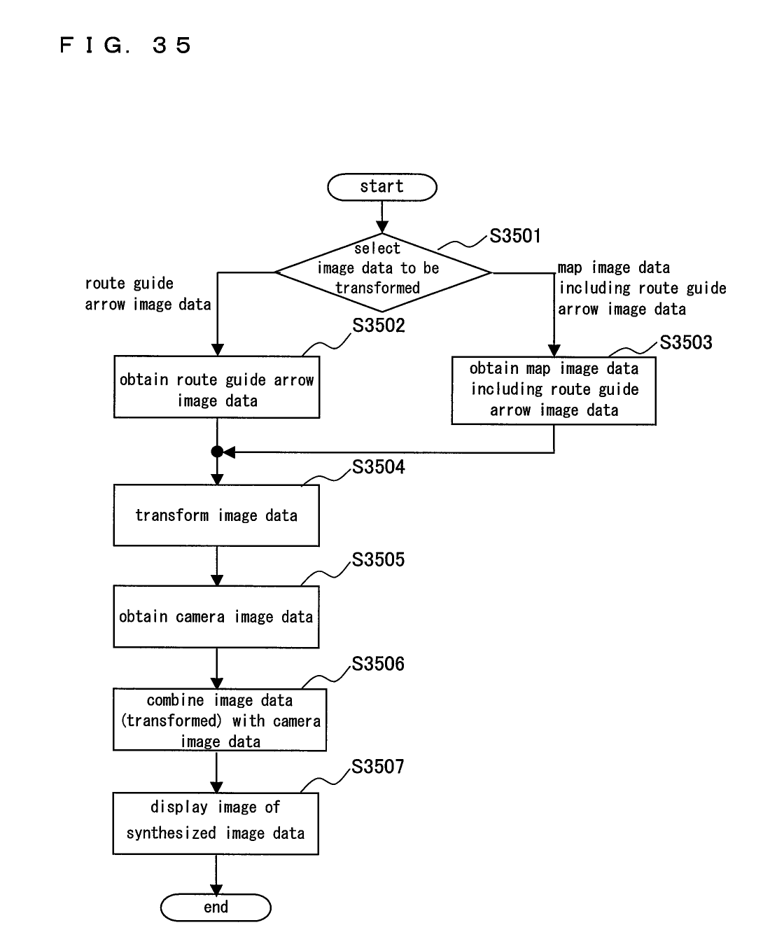

In view of the structural concept described so far, the image display method according to the preferred embodiment 6 is described below referring to a flow chart illustrated in FIG. 35. In Step S3501, the image conversion processing unit 208 selects the route guide image data as the image data to be transformed. In Step S3501, the route guide image data selected as the image data to be transformed is selected. According to the present preferred embodiment, since the route guide image arrow data is selected in Step S3501, the coordinate conversion processing unit 208, in Step S3502, obtains the route guide arrow image data from the navigation control unit 106. In Step S3504, the coordinate conversion processing unit 208 transforms the obtained route guide arrow image data and outputs the resulting data to the image synthesis processing unit 111. In Step S3505, the image synthesis processing unit 111 obtains the camera image data. In Step S3506, the image synthesis processing unit 111 combines the route guide arrow image data (transformed) inputted from the coordinate conversion processing unit 208 with the camera image data in such a way that their positional coordinates correspond to each other, and then supplies the combined image data to the image display processing unit 112. In Step S3507, the image display processing unit 112 displays an image of the combined image data supplied from the image synthesis processing unit 111.

According to the structure and the method described so far, the route guide arrow image data is read from the navigation apparatus, and the read route guide arrow image data is image-transformed depending on its distortions, so that the route guide image data (transformed) is generated. Then, the generated route guide image data (transformed) is combined with the camera image data in such a way that their point of interest coordinates correspond to each other, and the image of the combined image data is displayed (see FIG. 22).

### Preferred Embodiment 7

An image display method and an image display apparatus according to a preferred embodiment 7 of the present invention are described referring to FIGS. 1, 2, 23-25 and 35. The present preferred embodiment is structurally similar to the preferred embodiment 6, however, includes the following differences.

In the present preferred embodiment, the coordinate conversion processing unit 208, in addition to the operations described in the preferred embodiments 1-5, reads a map image data including a route guide arrow image data whose image is illustrated in FIG. 23 from the navigation control unit 106 as the route guide image data. The map image data including the route guide arrow image data is, for example, an image data obtained by combining the map image data illustrated in FIG. 9 with the route guide arrow image data A2101 illustrated in FIG. 21 in such a way that their positional coordinates correspond to each other, so that the car can be guided at an intersection according to the image data.

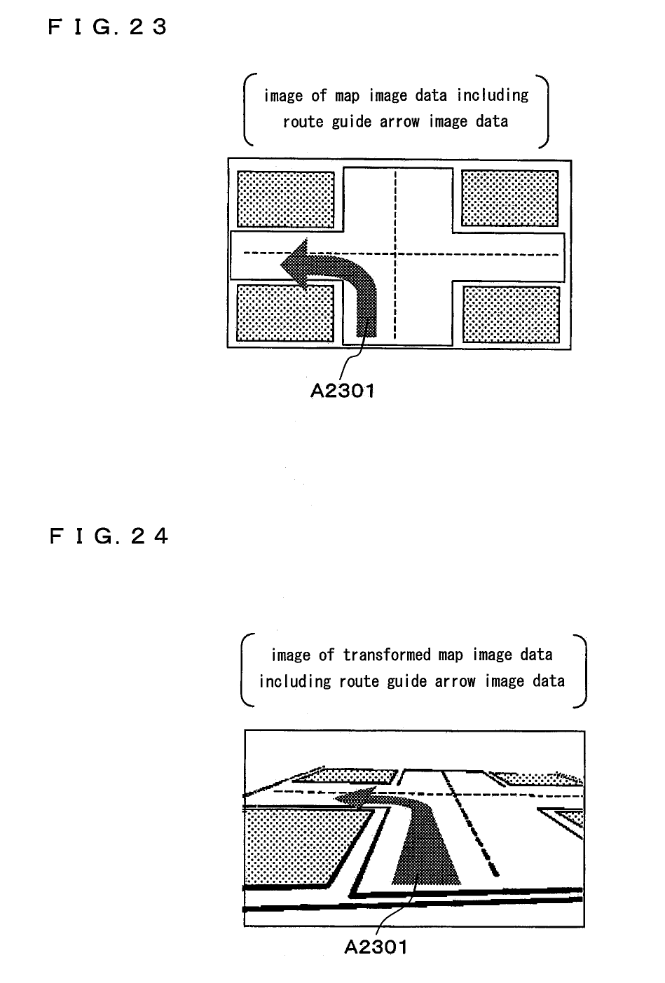

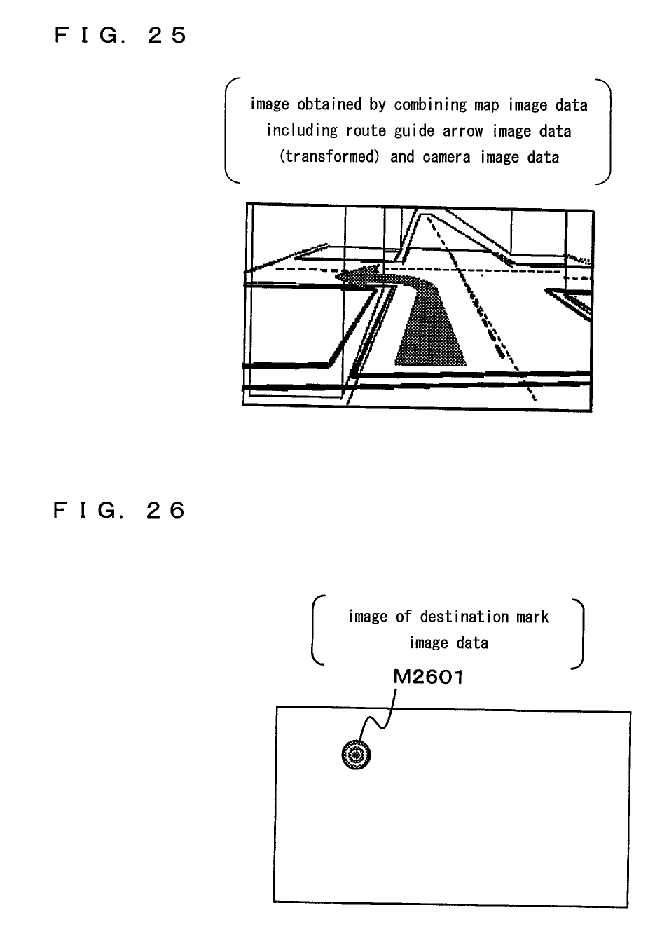

The coordinate conversion processing unit 208 implements the coordinate conversion described in the preferred embodiments 1-5 to the map image data including the route guide arrow image data to create a map image data including a route guide arrow image data (transformed) illustrated in FIG. 24, and outputs the created map image data including the route guide arrow image data (transformed) to the image synthesis processing unit 111. In the present preferred embodiment, the image synthesis processing unit 111 combines the map image data including the route guide arrow image data (transformed) with the camera image data. In this case, the camera image data is selected by the selector 113. Taking the camera image data whose image is illustrated in FIG. 6 for instance, the camera image data is combined with the map image data including the route guide arrow image data (transformed) illustrated in FIG. 24 in such a way that their positional coordinates correspond to each other, and an image illustrated in FIG. 25 is obtained from the combined image data. A synthesis coefficient (layer transparency) in the image synthesis can be changed without any restriction. The image synthesis processing unit 111 outputs the combined image data to the image display processing unit 112. The image display processing unit 112 displays an image of the combined image data on a display screen.

In view of the structural concept described so far, the image display method according to the preferred embodiment 7 is described below referring to the flow chart illustrated in FIG. 35. In Step S3501, the navigation control unit 106 selects the image data to be used as the route guide image data, and outputs the selected image data to the selector 207. In the present preferred embodiment, the navigation control unit 106 selects and outputs the map image data including the route guide arrow image data. The selector 207 is supplied with the route guide image data and the camera image data, and the route guide image data is selected and outputted in the present preferred embodiment. The coordinate conversion processing unit 208 obtains the map image data including the route guide arrow image data which is the route guide image data (Steps S3502 and S3502).

In Step S3504, the coordinate conversion processing unit 208 implements the coordinate conversion to the map image data including the route guide arrow image data supplied from the selector 207 to generate the map image data including the route guide arrow image data (transformed), and outputs the generated map image data to the image synthesis processing unit 111. In Step S3505, the selector 113 selects image data to be combined from either the camera image data or the map image data, and outputs the selected image data to the image synthesis processing unit 111. In the present preferred embodiment, the selector 113 selects the camera image data as the image data to be combined. Accordingly, the image synthesis processing unit 111 obtains the camera image data selected as the image data to be combined and the map image data including the route guide arrow image data (transformed). In Step S3506, the image synthesis processing unit 111 combines the route guide image data (transformed) with the camera image data in such a way that their point of interest coordinates correspond to each other, and outputs the combined image data to the image display processing unit 112. In Step S3507, the image display processing unit 112 displays an image of the combined image data.

According to the structure and the method described so far, the map image data including the route guide arrow image data is read from the navigation control unit 106, and the image transformation suitable for the distortions (relative positional relationship between the map image data and the camera image data to be calculated by the point of interest coordinate detection unit 206) is carried out to the read map image data including the route guide arrow image data. Then, the transformed map image data including the route guide arrow image data (transformed) is combined with the camera image data in a given synthesis proportion in such a way that their point of interest coordinates correspond to each other, and an image of the combined image data (illustrated in FIG. 25) is displayed.

### Preferred Embodiment 8

An image display method and an image display apparatus according to a preferred embodiment 8 of the present invention are described referring to FIGS. 1, 2, 26-28 and 36. The present preferred embodiment is structurally similar to the preferred embodiment 6, however, includes the following differences.

In the present preferred embodiment, the coordinate conversion processing unit 208, in addition to the operations described in the preferred embodiments 1-5, reads a destination mark image data M2601 from the navigation control unit 106. The destination mark image data M2601, an image of which is illustrated in FIG. 26, is an example of the route guide image data, indicating a destination position on an image so that the car can be guided to the destination.

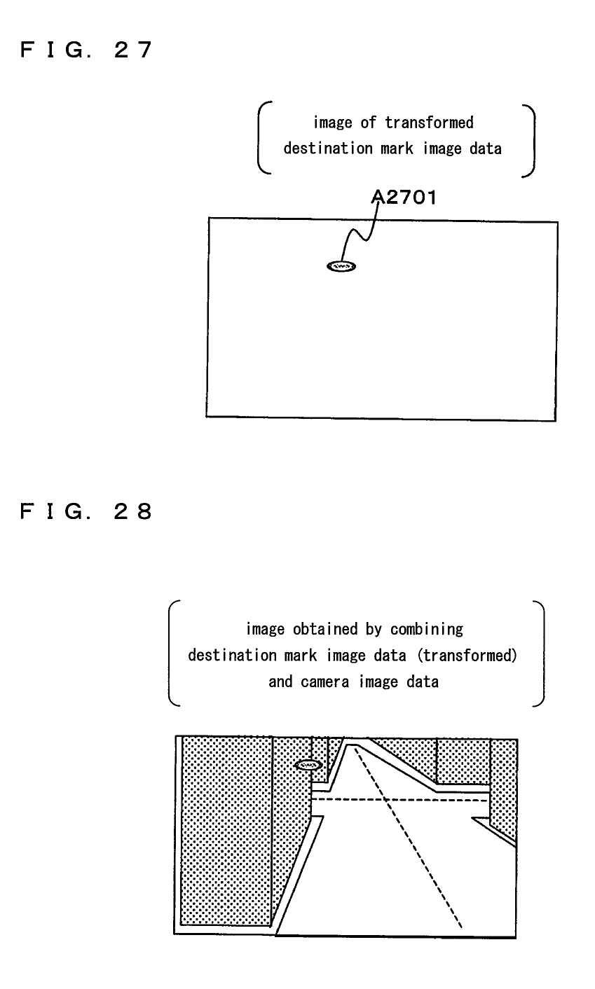

The coordinate conversion processing unit 208 implements the coordinate conversion described in the preferred embodiments 1-5 to the destination mark image data M2601 so that the destination mark image data M2601 illustrated in FIG. 27 is transformed. Hereinafter, the transformed destination mark image data M2601 is called a destination mark image data (transformed) A2701. The coordinate conversion processing unit 208 outputs the generated destination mark image data (transformed) A2701 to the image synthesis processing unit 111. According to the structure of the present preferred embodiment, the selector 113 selects the camera image data and outputs the selected camera image data to the image synthesis processing unit 111. The image synthesis processing unit 111 combines the camera image data with the destination mark image data (transformed) A2701 in such a way that their positional coordinates correspond to each other. The image synthesis processing unit 111 then outputs the combined image data to the image display processing unit 112. The image display processing unit 112 displays an image of the inputted combined image data on a display screen. Taking the image illustrated in FIG. 4 for example, the camera image data is combined with the destination mark image data (transformed) A2701, and an image illustrated in FIG. 28 is obtained from the combined image data.

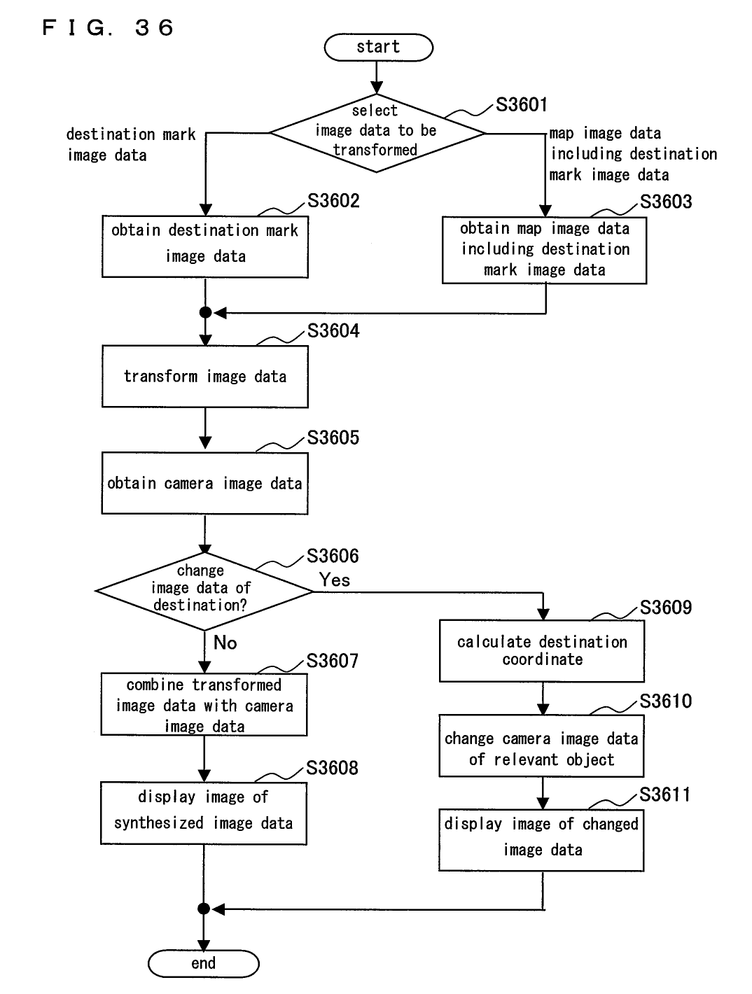

In view of the structural concept described so far, the image display method according to the preferred embodiment 8 is described below referring to a flow chart illustrated in FIG. 36. In Step S3601, the navigation control unit 106 selects the image data to be used as the route guide image data, and outputs the selected image data to the selector 207. In the present preferred embodiment, the destination mark image data M2601 is selected and outputted from the navigation control unit 106. To the selector 207 are inputted the route guide image data (destination mark image data M2601) from the navigation control unit 106 and the camera image data from the luminance signal processing unit 203 and the color difference signal processing unit 204. In the present preferred embodiment, the selector 207 selects the destination mark image data M2601 inputted from the navigation control unit 106 and sends the selected data to the coordinate conversion processing unit 208, and the coordinate conversion processing unit 208 receives the destination mark image data M2601 (Steps S3602 and S3603). The coordinate conversion processing unit 208 provides the image transformation processing to the obtained destination mark image data M2601 (Step S3604).

On the other hand, to the selector 113 are inputted the destination mark image data M2601 from the navigation control unit 106 and the camera image data from the luminance signal processing unit 203 and the color difference signal processing unit 204. In the present preferred embodiment, the selector 113 selects the camera image data inputted from the luminance signal processing unit 203 and the color difference signal processing unit 204, and sends the selected camera image data to the image synthesis processing unit 111, and the image synthesis processing unit 111 obtains the camera image data (Step S3605). Then, the image synthesis processing unit 111 determines whether or not a target image change mode is set (Step S3606). In the present preferred embodiment, since the target image change mode is not set, the processing proceeds to Step S3607. In Step S3607, the image synthesis processing unit 111 combines the destination mark image data (transformed) with the camera image data in such a way that their positional coordinates correspond to each other, and outputs the combined image data to the image display processing unit 112. The image display processing unit 112 displays the combined image data supplied from the image synthesis processing unit 111 (Step S3608). An image of the displayed image data is illustrated in FIG. 28.

According to the structure and the method described so far, the destination mark image data is read from the navigation control unit 106, and the read image data is subjected to image transformation depending on its distortions. Then, the obtained destination mark image data (transformed) is combined with the camera image data in such a way that their point of interest coordinates correspond to each other, and an image of the combined image data is displayed.

### Preferred Embodiment 9

An image display method and an image display apparatus according to a preferred embodiment 9 of the present invention are described referring to FIGS. 1, 2, 29-31, and 36. The present preferred embodiment is structurally similar to the preferred embodiment 6, however, includes the following differences.

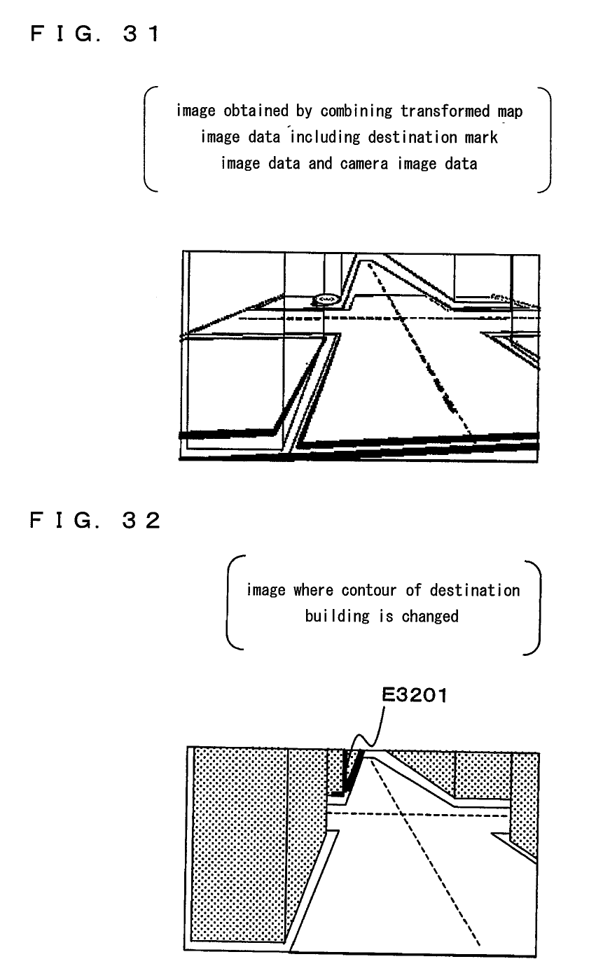

In the present preferred embodiment, the coordinate conversion processing unit 208, in addition to the operations described in the preferred embodiments 1-5, reads a map data including a destination mark image data from the navigation control unit 106. Below is given a description in further detail. The coordinate conversion processing unit 208 transforms a map image data M2901 including a destination mark image data, which is an example of the route guide image data, into a map image data including a destination mark whose image is illustrated in FIG. 30 in the same manner as described in the preferred embodiments 1-5. Hereinafter, the guide map image data including the destination mark image data obtained by the transformation is called a map image data (transformed) A3001 including a destination mark image data M. The coordinate conversion processing unit 208 outputs the created map image data (transformed) A3001 including the destination mark image data to the image synthesis processing unit 111. In the present preferred embodiment, the selector 113 selects the camera image data and outputs the selected camera image data to the image synthesis processing unit 111. The image synthesis processing unit 111 combines the camera image data with the map image data (transformed) A3001 including the destination mark image data in such a way that their point of interest coordinates correspond to each other, and outputs the combined image data thereby obtained to the image display processing unit 112. The image display processing unit 112 displays an image of the inputted combined image data on a display screen. Taking the camera image data whose image is illustrated in FIG. 4 for example, the camera image data is combined with the map image data (transformed) A3001 including the destination mark image data whose image is illustrated in FIG. 30. Then, an image illustrated in FIG. 31 is obtained from the combined image data. A synthesis coefficient (layer transparency) of the camera image data and map image data in the image synthesis can be changed without any restriction.

In view of the structural concept described so far, the image display method according to the preferred embodiment 9 is described below referring to the flow chart illustrated in FIG. 36. In Step S3601, the navigation control unit 106 selects the image data to be used as the route guide image data, and outputs the selected image data to the selector 207. In the present preferred embodiment, the map image data M2901 including the destination mark image data is selected and outputted from the navigation control unit 106. To the selector 207 are inputted the map image data M2901 including the destination mark image data from the navigation control unit 106 and the camera image data from the luminance signal processing unit 203 and the color difference signal processing unit 204. In the present preferred embodiment, the selector 207 selects the map image data M2901 including the destination mark image data supplied from the navigation control unit 106, and inputs the selected image data to the coordinate conversion processing unit 208. The coordinate conversion processing unit 208 then obtains the map image data M2901 including the destination mark image data (Steps 3602 and S3603). The coordinate conversion processing unit 208 image-transforms the inputted map image data M2901 including the destination mark image data supplied thereto (Step S3604). Hereinafter, the transformed map image data M2901 including the destination mark image data is called a map image data (transformed) A2901 including the destination mark image data.

On the other hand, the selector 113 is supplied with the map image data M2901 including the destination mark image data from the navigation control unit 106 and the camera image data from the luminance signal processing unit 203 and the color difference signal processing unit 204. In the present preferred embodiment, the selector 113 selects the camera image data supplied from the luminance signal processing unit 203 and the color difference signal processing unit 204, and sends the selected camera image data to the image synthesis processing unit 111. The image synthesis processing unit 111 then obtains the camera image data (Step S3605). Then, the image synthesis processing unit 111 determines whether or not a target image change mode is set (Step S3606). The target image change mode is not set in the present preferred embodiment, and the processing proceeds to Step S3607. In Step S3607, the image synthesis processing unit 111 combines the map image data (transformed) M2901 including the destination mark image data with the camera image data in such a way that their point of interest coordinates correspond to each other to create the combined image data, and outputs the combined image data to the image display processing unit 112. The image display processing unit 112 displays the combined image data inputted from the image synthesis processing unit 111 (Step S3608). An image thereby displayed is illustrated in FIG. 31.

According to the structure and the method described so far, the map image data including the destination mark image data is read from the navigation control unit 106, and the read image data is subjected to image transformation depending on its distortions. Then, the obtained map image data including the destination mark image data (transformed) is combined with the camera image data in such a way that their point of interest coordinates correspond to each other, and an image of the combined image data is displayed.

### Preferred Embodiment 10

An image display method and an image display apparatus according to a preferred embodiment 10 of the present invention are described referring to FIGS. 1, 2, 26, 27, 32, 33, and 36. The present preferred embodiment is structurally similar to the preferred embodiment 6, however, includes the following differences.

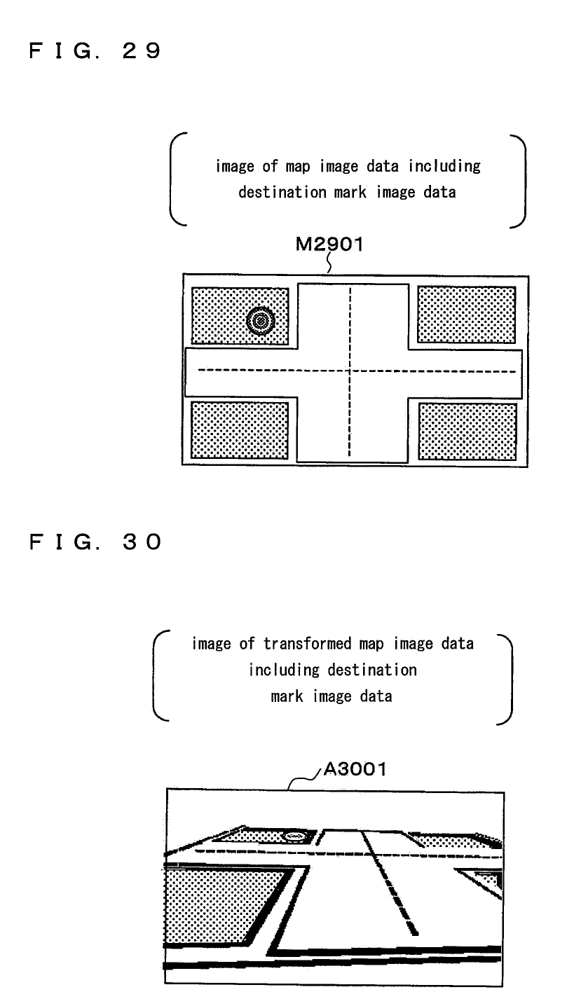

In the present preferred embodiment, the coordinate conversion processing unit 208, in addition to the operations described in the preferred embodiments 1-5, reads a map data including the destination mark image data M2601 or the destination mark image data M2901 from the navigation control unit 106. For example, when the map image data whose image is illustrated in FIG. 9 and the destination mark image data M2601 whose image is illustrated in FIGS. 26 and 29 are combined with each other in such a way that their positional coordinates correspond to each other, the car can be guide to its destination. Below is given a more detailed description. The coordinate conversion processing unit 208 converts the destination mark image data M2601 into a destination mark image data (transformed) A2701 illustrated in FIGS. 27 and 30 in the same manner as described in the preferred embodiments 1-5, and outputs the coordinate-converted image data to the image synthesis processing unit 111. In the present preferred embodiment, the selector 113 selects the camera image data and outputs the selected camera image data to the image synthesis processing unit 111. The image synthesis processing unit 111 image-adjusts the camera image data based on the destination mark image data (transformed) A2701 to generate an adjusted image data. When the camera image data illustrated in FIG. 4 is used as the camera image data, for example, contour information of the camera image data surrounding or near the coordinates of the destination mark in the destination mark image data (transformed) A2701 is changed. The image synthesis processing unit 111 can obtain the contour information of the camera image data by using the data from the luminance signal processing unit 203. FIG. 32 illustrates an exemplary image obtained from a camera image data E3201 in which the contour information is thus changed. The image synthesis processing unit 111 outputs the camera image data E3201 in which the contour information is changed to the image display processing unit 112. The image display processing unit 112 displays an image of the inputted camera image data E3201 on a display screen.

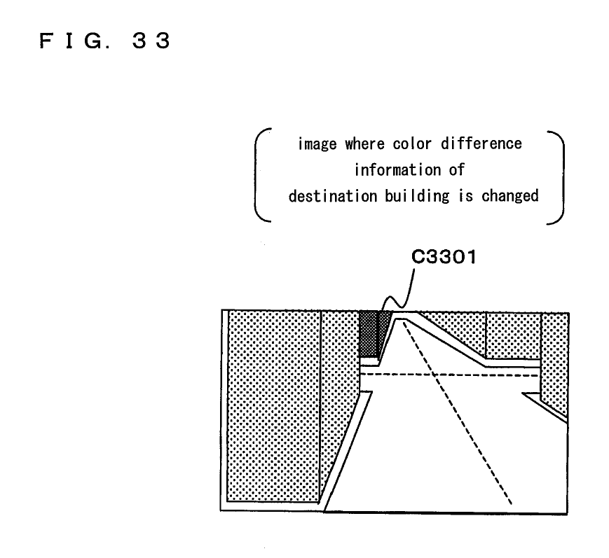

The image synthesis processing unit 111 not only changes the contour information of the camera image data but also can change the color difference information of the image data surrounding or near the coordinates of the destination mark. The image display processing unit 112 can obtain the color difference information of the camera image data by using the data from the color difference signal processing unit 204. FIG. 33 illustrates an exemplary image obtained from a camera image data E3301 in which the color difference information is thus changed.

In view of the structural concept described so far, the image display method according to the preferred embodiment 10 is described below referring to the flow chart illustrated in FIG. 36. In Step S3601, the navigation control unit 106 outputs the destination mark image data M2601 to the selector 207. To the selector 207 are inputted the destination mark image data M2601 from the navigation control unit 106 and the camera image data from the luminance signal processing unit 203 and the color difference signal processing unit 204. In the present preferred embodiment, the selector 207 selects the destination mark image data M2601 inputted from the navigation control unit 106 and sends the selected data to the coordinate conversion processing unit 208, and the coordinate conversion processing unit 208 then receives the destination mark image data M2601 (Steps S3602 and S3603). The coordinate conversion processing unit 208 provides the image transformation processing to the obtained destination mark image data M2601 (Step S3604). Hereinafter, the image-transformed destination mark image data M2601 is called the destination mark image data (transformed) A2701.

The selector 113 is supplied with the destination mark image data M2601 from the navigation control unit 106 and the camera image data from the luminance signal processing unit 203 and the color difference signal processing unit 204. In the present preferred embodiment, the selector 113 selects the camera image data supplied from the luminance signal processing unit 203 and the color difference signal processing unit 204, and sends the selected camera image data to the image synthesis processing unit 111. The image synthesis processing unit 111 thus obtains the camera image data (Step S3605). Then, the image synthesis processing unit 111 determines whether or not a target image change mode is set (Step S3606). The target image change mode is set in the present preferred embodiment, and the processing proceeds to Step S3609. Then, the image synthesis processing unit 111 calculates the coordinates of the destination mark in the destination mark image data (transformed) A2701 (Step S3609). Next, the image synthesis processing unit 111 adjusts the camera image data surrounding or near the calculated coordinates to generate the adjusted image data, and outputs the generated data to the image display processing unit 112 (Step S3610). The image data is adjusted by changing the contour information or the color difference information. The image display processing unit 112 displays the adjusted image data supplied from the image synthesis processing unit 111 (Step S3611). FIG. 31 or 32 illustrates an image thereby displayed.

According to the structure and the method, the information of the destination to which the car should be guided is read from the navigation apparatus, and the image transformation is carried out depending on the calculated distortions. Further, the camera image data can be adjusted so that an image of an object at target coordinates (contour or color difference) is highlighted.

The preferred embodiments of the present invention were described so far. According to the preferred embodiments, the map image data is checked to see whether or not there is an intersection ahead for the car to enter, and the direction of the road a driver should pay attention is calculated beforehand when there is such an intersection. Therefore, an image of the intersection can be displayed as soon as the car enters the intersection. Thus, safe driving can be assisted by alerting the driver or a passenger.

In the preferred embodiments, the intersection image obtained by the camera is displayed in the route guide mode in which the recommended route to the destination is set; however, the intersection image can be displayed in any mode other than the route guide mode. In any mode, a next intersection located where the road on which the car is travelling crosses another road can be determined based on a current position of the car and map image data, so that a predetermined direction in which the road is heading at the intersection is calculated.

In the preferred embodiments, such an intersection as a crossroad is used in the description. The present invention can be applied to other types of intersections such as T intersection, trifurcated road and junction of many roads. The intersection is not necessarily limited to an intersection between priority and non-priority roads, and includes an intersection where a traffic light is provided and an intersection of roads with a plurality of lanes.

In the preferred embodiments, the description is made using two-dimensional map image data is obtained from the navigation apparatus. The present invention is similarly feasible when a three-dimensional map image data, such as an aerial view, is used.

The description of the invention in the respective preferred embodiments is made on condition that the route guide image data and the destination mark image data from the navigation apparatus are combined with the camera image data to assist the car driver in navigation. The present invention is similarly feasible when various types of other guide image data are combined with any other particular image data.

In the preferred embodiments, since it is unnecessary to consider the height, direction and optical conditions of the installed camera, it is easy to set the camera, resulting in cost reduction. Further, the car can be accurately guided through an intersection even if a position indicated by map information does not precisely correspond with an actual position of the car. Further, route guide can be made even if the center of an intersection does not precisely correspond with the center of a camera's viewing angle and as a result the guide can continue up to the point where the car turns right or left or completes the turn.

The present invention was so far described referring to the preferred embodiments, however, its technical scope is not necessarily limited to the various modes described in the preferred embodiments, and it is obvious to the ordinarily skilled in the art that various modifications or improvements can be made therein.

It is evidently known from the Scope of Claims that the technical scope of the present invention can include such modified or improved modes.

### INDUSTRIAL APPLICABILITY

An image transformation method, an image transformation apparatus, image display method and image display apparatus according to the present invention can be used in a computer apparatus equipped with a navigation feature. Such a computer apparatus may include an audio feature, a video feature or any other feature in addition to the navigation feature.

1. An image transformation method wherein an image transformation apparatus carries out:
a first step in which a first road shape included in a camera image data generated by a camera that catches surroundings of a car equipped with the camera is recognized based on the camera image data; and
a second step in which a map image data of a vicinity of the car is read from a navigation apparatus, second point of interest coordinates present in a second road shape included in the read map image data and first point of interest coordinates present in the first road shape are respectively detected, and the first point of interest coordinates and the second point of interest coordinates are arranged to correspond to each other.

2. The image transformation method as claimed in claim 1, wherein a contour component in the camera image data is detected based on a luminance signal of the camera image data, and the first road shape is recognized based on the contour component at an edge portion of a second image region having color difference information equal to a color difference information of a first image region estimated as a road in the camera image data in the first step.

3. The image transformation method as claimed in claim 1, wherein
a road contour is recognized as the first road shape in the first step, second intersection contour coordinates in a road region are detected as the second point of interest coordinates in the map image data in the second step, and flexion point coordinates in the road contour are recognized as first intersection contour coordinates so that the recognized first intersection contour coordinates are detected as the first point of interest coordinates in the camera image data in the second step.

4. The image transformation method as claimed in claim 1, wherein
a road contour is recognized as the first road shape in the first step, first intersection contour coordinates in a road region are recognized as the first point of interest coordinates in the camera image data in the second step, and in the case where the recognized first point of interest coordinates are insufficient as the first intersection contour coordinates, the insufficient first point of interest coordinates are estimated based on the recognized first point of interest coordinates in the second step.

5. The image transformation method as claimed in claim 1, wherein
a road contour is recognized as the first road shape in the first step, second intersection contour coordinates in a road region are detected as the second point of interest coordinates in the map image data in the second step, and a first direction vector of a contour component in the camera image data is detected and first intersection contour coordinates are then recognized based on the detected first direction vector so that the recognized first intersection contour coordinates are detected as the first point of interest coordinates in the second step.

6. The image transformation method as claimed in claim 1, further including a third step in which a distortion generated between the first point of interest coordinates and the second point of interest coordinates that are arranged to correspond with each other is calculated, and coordinates of the map image data or the camera image data are converted so that an image of the map image data or the camera image data is transformed based on the calculated distortion.

7. The image transformation method as claimed in claim 6, wherein
the distortion is calculated so that the first point of interest coordinates and the second point of interest coordinates correspond with equal to each other in the third step.

8. The image transformation method as claimed in claim 6, wherein
a second direction vector of a road region in the map image data and a first direction vector of a contour component in the camera image data are detected in the second step, the first direction vector and the second direction vector are arranged to correspond to each other in such a way that the first and second direction vectors make a minimum shift relative to each other in the third step, and the distortion is calculated based on a difference between the first and second direction vectors arranged to correspond with each other in the third step.

9. An image display method comprising:
the first and second steps of the image transformation method claimed in claim 1 and a fourth step, wherein
the camera image data and the map image data are combined with each other in the state where the first point of interest coordinates and the second point of interest coordinates correspond to each other, and an image of the combined image data is displayed in the fourth step.

10. An image display method comprising:
the first-third steps of the image transformation method claimed in claim 6 and a fifth step, wherein
a route guide image data positionally corresponding to the map image data is further read from the navigation apparatus in the first step,
coordinates of the route guide image data are converted in place of those of the map image data or the camera image data so that an image of the route guide image data is transformed based on the distortion in the third step, and
the transformed route guide image data and the untransformed camera image data are combined with each other in such a way that an image of the transformed route guide image data positionally corresponds to an image of the untransformed camera image data, and an image of the combined image data is displayed in the fifth step.

11. An image display method comprising:
the first-third steps of the image transformation method claimed in claim 6 and a sixth step, wherein
a map image data including a route guide image data is read from the navigation apparatus as the map image data in the first step,
coordinates of the map image data including the route guide image data are converted so that an image of the map image data including the route guide image data is transformed based on the distortion in the third step, and
the transformed map image data including the route guide image data and the untransformed camera image data are combined with each other in such a way that an image of the transformed map image data including the route guide image data positionally corresponds to an image of the untransformed camera image data, and an image of the combined image data is displayed in the sixth step.

12. The image display method claimed in claim 10, wherein
the route guide image data is an image data indicating a position of a destination to which the car should be guided.

13. The image display method claimed in claim 10, wherein
the route guide image data is an image data indicating a direction leading to a destination to which the car should be guided.

14. The image display method claimed in claim 11, wherein
the route guide image data is an image data indicating a position of a destination to which the car should be guided.

15. The image display method claimed in claim 11, wherein
the route guide image data is an image data indicating a direction leading to a destination to which the car should be guided.

16. An image transformation apparatus comprising:
an image recognition unit for recognizing a first road shape in a camera image data generated by a camera that catches surroundings of a car equipped with the camera based on the camera image data;
a point of interest coordinate detection unit for reading a map image data of a vicinity of the car from a navigation apparatus, detecting second point of interest coordinates present in a second road shape included in the read map image data and first point of interest coordinates present in the first road shape, and arranging the first point of interest coordinates and the second point of interest coordinates to correspond to each other; and
a coordinate conversion processing unit for calculating a distortion generated between the first point of interest coordinates and the second point of interest coordinates arranged to correspond to each other by the point of interest coordinate detection unit, and converting coordinates of the map image data or the camera image data so that an image of the map image data or the camera image data is transformed based on the calculated distortion.

17. The image transformation apparatus as claimed in claim 16, wherein the image recognition unit comprises:
a luminance signal/color difference signal division processing unit for extracting a luminance signal and a color difference signal from the camera image data;
a luminance signal processing unit for generating a contour signal based on the luminance signal;
a color difference signal processing unit for extracting a color difference signal in an image region estimated as a road in the camera image data from the camera image data; and
an image recognition unit for recognizing the first road shape based on the contour signal and the color difference signal in the image region.

18. An image display apparatus comprising:
the image transformation apparatus as claimed in claim 16;
an image synthesis processing unit for creating a combined image data by combining the camera image data and the coordinate-converted map image data with each other or combining the coordinate-converted camera image data and the map image data with each other in the state where point of interest coordinates of these data are arranged to correspond to each other, and
an image display processing unit for creating a display signal based on the combined image data.

19. The image display apparatus as claimed in claim 18, wherein
the coordinate conversion processing unit further reads a route guide image data positionally corresponding to the map image data from the navigation apparatus, and converts coordinates of the route guide image data so that an image of the route guide image data is transformed based on the distortion, and
the image synthesis processing unit combines the coordinate-converted route guide image data and the camera image data with each other so that an image of the transformed route guide image data positionally corresponds to an image of the untransformed camera image data.

20. The image display apparatus as claimed in claim 19, wherein
the coordinate conversion processing unit reads a map image data including a route guide image data positionally corresponding to the map image data from the navigation apparatus as the map image data, and converts coordinates of the map image data including the route guide image data so that an image of the map image data including the route guide image data is transformed based on the distortion, and
the image synthesis processing unit combines the coordinate-converted map image data including the route guide image data and the camera image data with each other so that an image of the transformed map image data including the route guide image data positionally corresponds to an image of the untransformed camera image data.

21. The image display apparatus as claimed in claim 19, wherein
the route guide image data is an image data indicating a position of a destination to which the car should be guided.

22. The image display apparatus claimed in claim 19, wherein
the route guide image data is an image data indicating a direction leading to a destination to which the car should be guided.

23. The image display apparatus as claimed in claim 21, wherein
the image synthesis processing unit adjusts a luminance signal or a color difference signal of a region relevant to the camera image data positionally corresponding to an image data indicating a destination position to which the car should be guided which is the coordinate-converted route guide image data, and then combines the adjusted signal with the route guide image data.
